(19) United States
(12) Patent Application Publication
(10) Pub. No.: US 2022/0357261 A1
(43) Pub. Date: Nov. 10, 2022

(54) DEVICE FOR DETECTING LIQUID CONTENT IN AN AEROSOL AND METHOD OF USING THE SAME

(71) Applicant: Honeywell International Inc., Charlotte, NC (US)

(72) Inventors: Andy Walker Brown, Richardson, TX (US); Adam D. McBrady, Dallas, TX (US); Stephan Michael Bork, Murphy, TX (US)

(21) Appl. No.: 17/314,420

(22) Filed: May 7, 2021

(51) Int. Cl. G01N 15/02; G01N 15/08

(52) U.S. Cl. CPC G01N 15/0227; G01N 15/0826

(57) ABSTRACT

Various embodiments are directed to a device for detecting a particle liquid content characteristic comprising: one or more fluid flow device inlets configured to receive at least one fluid sample comprising a first plurality of particles and a second plurality of particles, the device being configured to determine a particle liquid content characteristic based at least in part on a comparison of first particle data and second particle data. In various embodiments, the device may comprise a heating element configured to heat at least a portion of particles within the second fluid sample. In various embodiments, the device may comprise a fluid sensor configured to generate first particle data using an optical scattering operation and a fluid composition sensor configured to generate second particle data using a particle imaging operation. Various embodiments are directed to systems and methods for controlling a fluid flow monitoring system.

### TECHNOLOGICAL FIELD

An example embodiment relates generally to devices used to estimate an abundance of airborne droplets (e.g., liquid content) within the air of an ambient environment, and operating a system configured to control one or more conditions within the ambient environment based at least in part on the estimation of the airborne droplets within the air.

### BACKGROUND

Sensors and devices may be utilized to characterize various aspects of fluids in a wide variety of applications. As just one example, sensor devices may be utilized for monitoring air conditions, such as monitoring and characterizing the particulate content of a flow of air. However, existing fluid sensor devices provide limited functionality in generating data indicative of certain characteristics of fluids, such as the unique identity and concentration of individual particles including droplets contained within a fluid flow. Fluid sensor devices can use particle imaging methods to characterize particle identity and concentration of particulate matter within a collected sample fluid. It is desirable to improve various aspects of particle and droplet sampling and analysis. In general, it can be advantageous for a fluid sampling device to identify and characterize an abundance of droplets present within the air in an environment to facilitate the avoidance of inhaling droplets containing dangerous pathogens and other harmful materials. For devices collecting data associated with a volume of air to determine an abundance of droplets therein, it is desirable to avoid measurement inaccuracies caused by the volatile nature of droplets present within the air and the limitations of various measurement devices in order to provide an accurate and effective characterization of the relative abundance of droplets within an environment.

Accordingly, a need exists for an improved fluid flow device capable of accurately collecting and analyzing particle content of a fluid sample from an ambient environment in order to estimate the abundance of droplets present within the air. Furthermore, there is also the need for HVAC and other building control systems to actively respond to the presence of airborne droplets in order to improve indoor air quality and mitigate potential health hazards conveyed by droplets.

### BRIEF SUMMARY

Various embodiments are directed to apparatuses and methods for detecting a particle liquid content characteristic. In various embodiments, a device for detecting a particle liquid content characteristic comprises: one or more fluid flow device inlets configured to receive a first fluid sample comprising a first plurality of particles and a second fluid sample comprising a second plurality of particles; a heating element configured to heat at least a portion of the second plurality of particles such that one or more of the second plurality of particles comprises one or more heated particles; a flow sensor configured to receive the first fluid sample and capture first particle data associated with the first plurality of particles; and a controller configured to determine a particle liquid content characteristic based at least in part on the first particle data and second particle data associated with the one or more heated particles, wherein the particle liquid content characteristic is defined at least in part by a liquid particle portion of one or more particles received by the fluid flow device.

In various embodiments, the flow sensor may comprise a fluid sensor configured to capture the first particle data associated with the first plurality of particles using an optical scattering operation. In various embodiments, the flow sensor may comprise a fluid composition sensor configured to capture the first particle data associated with the first plurality of particles using a particle imaging operation. In certain embodiments, the particle imaging operation may comprise lensless holography. Further, in various embodiments, the flow sensor may be further configured to receive the second fluid sample and capture the second particle data associated with the one or more heated particles. In various embodiments, the fluid flow device may further comprise a first fluid flow path configured to receive the first fluid sample and a second fluid flow path configured to receive the second fluid sample. In certain embodiments, the fluid flow device may further comprise a second flow sensor configured to receive the one or more heated particles from the second fluid delivery conduit and capture the second particle data associated with the at least a portion of the one or more heated particles. In certain embodiments, the second flow sensor may comprise a fluid sensor configured to capture the second particle data associated with the at least a portion of the one or more heated particles using an optical scattering operation.

In various embodiments, the particle liquid content characteristic may comprise a ratio defined at least in part by a first particle characteristic value and a second particle characteristic value, wherein the first particle characteristic value is defined by the first particle data associated with the first plurality of particles, and wherein the second particle characteristic value is defined by the second particle data associated with the one or more heated particles. In various embodiments, the particle liquid content characteristic may comprise a difference between a first particle characteristic value and a second particle characteristic value, wherein the first particle characteristic value is defined by the first particle data associated with the first plurality of particles, and wherein the second particle characteristic value is defined by the second particle data associated with the one or more heated particles. In various embodiments, the controller may be further configured to determine that the particle liquid content characteristic satisfies a threshold liquid content concentration value; and upon determining that the particle liquid content characteristic satisfies the threshold liquid content concentration value, generate a control signal for transmission to an external device. In various embodiments, the heating element may be configured to heat the at least a portion of the second plurality of particles within a fluid flow conduit fluidly connected to at least one of the one or more fluid flow device inlets such that at least a portion of the fluid flow conduit defines a heated flow path.

Various embodiments may be directed to a fluid flow device for detecting a particle liquid content characteristic, the device comprising: a fluid sensor configured to receive a fluid sample comprising a plurality of particles disposed therein and generate first particle data associated with the plurality of particles using an optical scattering operation; a fluid composition sensor configured to receive the fluid sample comprising the plurality of particles and generate second particle data associated with the plurality of particles using a particle imaging operation; a controller configured to determine a particle liquid content characteristic associated with the fluid sample based at least in part on a comparison of the first particle data and the second particle data, wherein the particle liquid content characteristic is defined at least in part by a liquid particle portion within one or more particles of the plurality received by the fluid flow device.

In various embodiments, the fluid composition sensor may comprise an imaging device configured to capture a particle image of one or more particles of the plurality using lensless holography. In various embodiments, the particle liquid content characteristic may be based at least in part on a ratio of a second particle characteristic value to a first particle characteristic value, wherein the second particle characteristic value is defined by the second particle data associated with the plurality of particles, and wherein the first particle characteristic value is defined by the first particle data associated with the plurality of particles. In various embodiments, the particle liquid content characteristic may be based at least in part on a difference between a second particle characteristic value and a first particle characteristic value, wherein the second particle characteristic value is defined by the second particle data associated with the plurality of particles, and wherein the first particle characteristic value is defined by the first particle data associated with the plurality of particles. Further, in various embodiments, the controller may be further configured to determine that the particle liquid content characteristic satisfies a threshold liquid content concentration value; and upon determining that the particle liquid content characteristic satisfies the threshold liquid content concentration value, generate a control signal for transmission to an external device. In various embodiments, the fluid sensor may define at least a portion of a fluid flow path, and wherein the fluid sensor and the fluid composition sensor are positioned along the fluid flow path such that the fluid sample flows through the fluid sensor upstream from the fluid composition sensor.

Various embodiments are directed to a method for controlling a fluid flow monitoring system, the method comprising: monitoring, via a fluid flow device, a particle liquid content characteristic associated with a fluid sample received by the fluid flow device, wherein the particle liquid content characteristic is defined at least in part by a liquid particle portion within one or more of the plurality of particles; and upon determining that the particle liquid content characteristic satisfies a particle liquid content threshold value, generating a control signal for transmission to second system device of the fluid flow monitoring system, wherein the particle liquid content threshold value defines a threshold particle liquid content concentration indicative of the presence of one or more droplets present within the fluid sample received by the fluid flow device.

In various embodiments, the method may further comprise, in response to receiving the receiving the control signal at the secondary system device, executing one or more responsive mitigating operations to reduce a particle liquid content concentration associated with the one or more particles within the fluid sample. Further, in various embodiments, executing the one or more responsive mitigating operations may comprise causing an ambient condition controller to adjust one or more ambient conditions defining at least a portion of an ambient environment within a facility. In various embodiments, the method may further comprise, in response to receiving the receiving the control signal at the secondary system device, transmitting an alert signal to one or more client devices associated with the fluid flow monitoring system.

### BRIEF DESCRIPTION OF THE DRAWINGS

Reference will now be made to the accompanying drawings, which are not necessarily drawn to scale, and wherein:

FIG. 1 is a schematic diagram of a fluid sensing system in accordance with an example embodiment of the present disclosure;

FIG. 2 illustrates a cross-sectional view of an exemplary apparatus in accordance with one embodiment described herein;

FIG. 3 illustrates a cross-sectional view of an exemplary apparatus in accordance with one embodiment described herein;

FIG. 4 illustrates a schematic view of an exemplary apparatus in accordance with various embodiments described herein;

FIG. 5 illustrates a schematic view of an exemplary apparatus in accordance with various embodiments;

FIGS. 6A-6B illustrate schematic views of an exemplary apparatus in accordance with various embodiments;

FIG. 7 illustrates a schematic view of an exemplary apparatus in accordance with various embodiments;

FIG. 8 is an illustrative flowchart of various steps for an example method in accordance with various embodiments of the present disclosure;

FIG. 9 is an illustrative flowchart of various steps for an example method in accordance with various embodiments of the present disclosure; and

FIG. 10 schematically illustrates various data flows within an exemplary system in accordance with some embodiments discussed herein.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

It should be understood at the outset that although illustrative implementations of one or more aspects are illustrated below, the disclosed assemblies, systems, and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents. While values for dimensions of various elements are disclosed, the drawings may not be to scale.

The words “example,” or “exemplary,” when used herein, are intended to mean “serving as an example, instance, or illustration.” Any implementation described herein as an “example” or “exemplary embodiment” is not necessarily preferred or advantageous over other implementations. As used herein, a “fluid” may be embodied as a gas, a liquid, or a combination of a gas and a liquid in a single flow. Thus, the term “fluid” encompasses various materials subject to flow, such as, but not limited to, liquids and/or gases (e.g., air, oil, or the like). Thus, various embodiments are directed to fluid sensing systems, such as gas sensing systems (e.g., certain embodiments being specifically configured for operation with air; other embodiments being configured for operation with other gases, such as inert gases, volatile gases, and/or the like), liquid sensing systems, and/or the like.

Certain embodiments are directed to a fluid flow device, a fluid flow monitoring system, and various methods of using the same in various environments. Described herein is a device (which may be referred to as a fluid flow device, a fluid particulate sensor, a gas particulate sensor, or an air particulate senor as discussed herein) configured to characterize and monitor particulate matter within a volume of fluid in order to provide an accurate estimation of the relative abundance of airborne droplets within the ambient environment. Airborne droplets are continuously exhaled or ejected during normal talking, breathing, sneezing, and coughing. Droplets can carry infectious pathogens such as viruses, bacterial, and fungi. A method to detect the abundance of airborne droplets would be a useful tool for monitoring and mitigating exposure to air that has a higher potential to infect people. Certain air quality sensors configured to identify and/or measure an amount of particulate within the air of an environment are not configured to distinguish between liquid content and solid content within a detected particle. Accordingly, such sensors may be incapable of determining the abundance of droplets—which are often of particular importance with respect to the spread of infection disease—present within the air of the environment.

Further, although certain fluid sensors may be configured to distinguish between detected liquid content and detected solid content, the volatile nature of the liquid content that defines a droplet disposed within the air of an environment can result in various measurement inaccuracies and/or an inability of a sensor to detect a particle within a droplet. For example, droplets dispersed within the air of an environment can exhibit a wide range of sizes (e.g., ranging from sub-micron to tens of microns). Generally, large particles that are greater than at least approximately 10 microns will tend to quickly fall out of the air. However, smaller airborne particles—including droplets and particles that are more likely to be trapped in the upper respiratory tract, lower respiratory tract, and/or lungs—can remain airborne and can be dispersed over long distances. Where most exhaled and expelled droplets can comprise a variety of liquid substances, such as, for example, water, the droplets are often subjected to evaporation over time, causing the droplets to shrink, which may change the way they are dispersed in the air and/or the composition of the droplet, thereby increasing the difficulty and complexity of associated with detecting, measuring, and/or characterizing a droplet within the air.

The devices and methods discussed herein may be configured to detect and characterize an abundance of airborne droplets present within a volume of fluid (e.g., air) in an environment. In various embodiments, the present invention utilizes one or more sensors configured to receive a first fluid sample and a second fluid sample from within an ambient environment. The present invention may be configured to apply heat to one of the two fluid samples in a deliberate, defined heating operation prior to the fluid sample being received and/or characterized by a fluid sensing device, as described herein. In various embodiments, both the first fluid sample and the second fluid sample, comprising the heated plurality particles therein, are received by flow sensors configured to capture particle data associated with the respective pluralities of particles. As described herein, the present invention may be configured to compare the first particle data associated with the unheated plurality of particles and the second particle data associated with the heated plurality of particles in order to identify one or more differences caused by an evaporation of liquid content from within the heated plurality of particles. The present invention is configured to determine the relative abundance of droplets within the air based at least in part on the comparison between the particle data associated with the heated fluid sample and the unheated fluid sample, respectively, and an isolation of one or more differences therebetween.

Further, in various embodiments, the present invention may include receiving a first fluid sample at a fluid sensor configured to capture first particle data using one or more optical scattering operations, and further, receiving a second fluid sample at a fluid composition sensor configured to capture second particle data using one or more particle imaging operations. Wherein the distinct operations and/or physical configurations of the fluid sensor and the fluid composition sensor may cause the second particle data to differ at least in part from the first particle data captured by the fluid sensor. In various embodiments, the present invention may be configured to compare the first particle data captured by the fluid sensor and the second particle data captured by the fluid composition sensor in order to identify one or more differences between the respective data. Further, the present invention may be configured to correlate the degree to which first particle data and/or the second particle data are affected by the distinct physical configurations exhibited by a fluid sensor and a fluid composition sensor to an abundance of droplets present in the air of an ambient environment. The systems, devices, and methods described herein may minimize sensor error and/or ineffectiveness with respect to the detection characterization of airborne droplets within an environment, thereby normalizing output data and improving data consistency. Further, the present invention embodies a more flexible sensor configuration that may be applicable in various use cases defined by different circumstances, configurations, and requirements. The present invention exploits a robust design to provide a fluid flow device, fluid flow monitoring system, and various related methods of using the same configured to measure the relative abundance of airborne droplets within an environment.

In various embodiments, an exemplary fluid flow device may be configured to receive a volume of fluid flowing therethrough. Specifically, the fluid flow device may be configured to receive a volume of a gas, such as air, flowing therethrough. In various embodiments, the fluid flow device may be configured to determine at least one particle characteristic of a plurality of particles within the volume of fluid based at least in part on particle data associated with at least a portion of the plurality of particles. For example, in various embodiments, a fluid flow device may comprise one or more flow sensors configured to collect, capture, generate, store, and/or the like various particle measurements associated with the plurality of particles within the volume of fluid, which may be utilized by an exemplary fluid flow device to generate corresponding particle data. As a non-limiting example, an exemplary fluid flow device may comprise one or more flow sensors configured to measure and/or characterize particle matter mass concentration data, particle quantity data, particle size data, and/or the like. Further, in various embodiments, a fluid flow device may comprise a controller configured to generate and/or process particle data associated with one or more particles within the received volume of fluid, and further, to determine a particle characteristic of the plurality of particles within the volume of fluid received by the fluid flow device. As described in further detail herein, an exemplary fluid flow device may be configured to detect, monitor, and/or characterize one or more particles comprising liquid content (e.g., droplets, aerosols) and solid content within one or more volumes of fluid (e.g., fluid samples) flowing therethrough. For example, in various embodiments, an exemplary particle may be defined at least in part by a liquid particle portion and a solid particle portion. In various embodiments, an exemplary fluid flow device may be configured to generate and/or process particle data based on one or more particle characteristics associated with a liquid particle portion and/or a solid particle portion, such as, for example, a liquid-to-solid particle content ratio, a liquid particle portion volume, and/or the like.

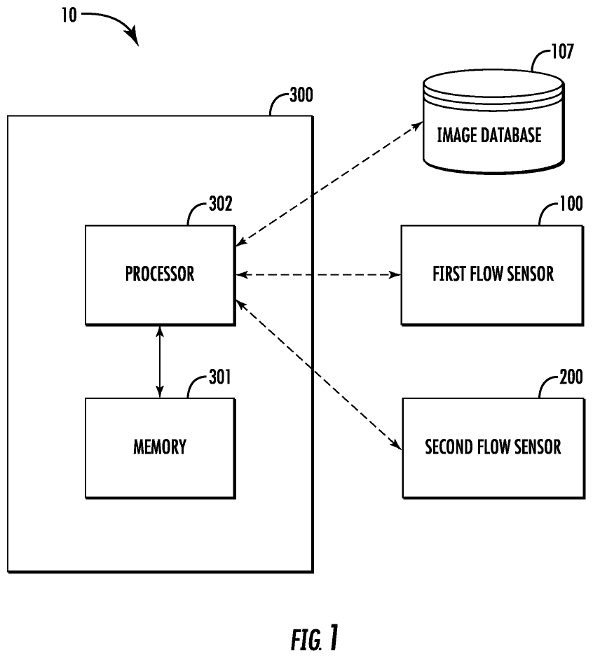

Referring now to FIG. 1, a schematic diagram of an exemplary fluid flow device 10 configured for fluid sensing is provided. The fluid flow device 10 may include, be associated with, or may otherwise be in communication with a controller 300, including, for example, one or more processors 302 and one or more memory devices 301, one or more flow sensors, such as, for example, a first flow sensor 100. In various embodiments, the one or more fluid sensors of an exemplary fluid flow device 10 may comprise a plurality of flow sensors including a first flow sensor 100 and a second flow sensor 200. Further, in various embodiments, an exemplary fluid flow device 10 may include, be associated with, or may otherwise be in communication with an image database 107. In various embodiments, the fluid flow device 10 may be embodied by or associated with a plurality of computing devices that are in communication with or otherwise networked with one another. For example, at least a portion of the one or more flow sensors, such as, for example, one or both of the first and second flow sensors 100, 200, may have a processor in communication with the other. In various embodiments, some or all of the referenced components may be embodied as a flow device. For example, an exemplary fluid flow device 10 may include a controller 300, including a processor 302 and a memory 301, a first flow sensor 100, a second flow sensor 200, and, optionally, an imaging database 107, as described in further detail herein.

In various embodiments, the one or more flow sensors of an exemplary fluid flow device may comprise any sensor configured for monitoring particle composition of one or more particles within a volume of fluid, such as, for example, by measuring and/or characterizing a particle matter mass concentration, particle quantity, particle size, and/or the like, associated with the one or more particles.

In various embodiments, the one or more flow sensors (e.g., a first flow sensor 100, a second flow sensor 200) of an exemplary fluid flow device 10 may comprise a fluid sensor comprising an optical scattering sensor. For example, a fluid sensor may be configured to detect, measure, and/or characterize a particle matter mass concentration, particle quantity, particle size, and/or the like associated with one or more particles within a fluid sample received by a fluid flow device based at least in part on optical scattering. As a non-limiting example, in certain embodiments, the fluid sensor may be embodied as a fluid (e.g., air) sensor comprising a particulate matter sensor (e.g., a Honeywell HPM Series Particulate Matter Sensor), a particle sizer/counter (e.g., a TSI OPS Series Optical Particle Sizer Sensor), and/or any other suitable devices capable of measuring particle content within one or more volumes of fluid using one or more optical scattering operations. In various embodiments, an exemplary a fluid sensor may comprise and/or be utilized in combination with a processor configured for generating various control signals, as described herein.

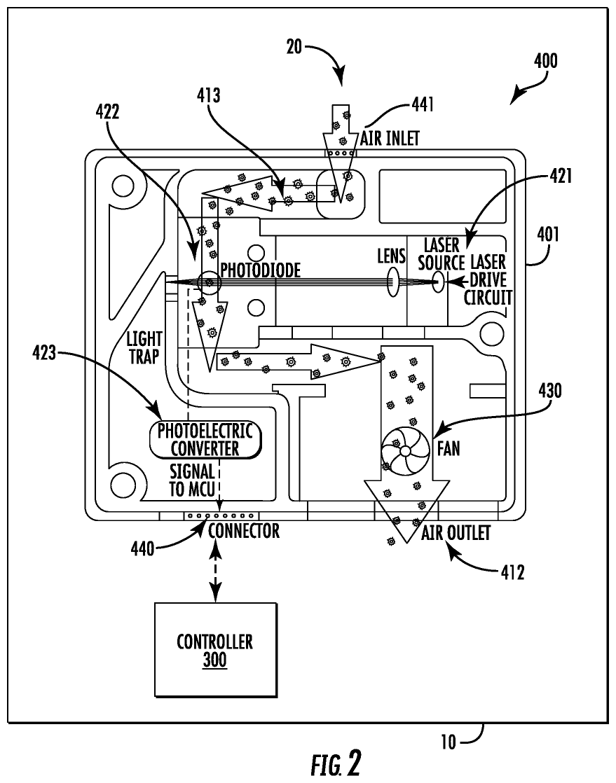

As described herein, in various embodiments, the first flow sensor may comprise a fluid sensor. For example, as illustrated in FIG. 2, an exemplary fluid sensor 400 may comprise an optical scattering sensor. In various embodiments, a first flow sensor comprising a fluid sensor, such as, for example, exemplary fluid sensor 400, may capture particle data associated with one or more of the first plurality of particles within the first fluid sample. For example, exemplary fluid sensor 400 may capture particle data, such as, for example, particle matter mass concentration data, particle quantity data, particle size data, and/or the like, associated with one or more of the first plurality of particles by utilizing a particle detector comprising a light beam generator and a pulse detector, collectively configured to monitor signal pulses generated at the pulse detector based upon the presence of the one or more particles within the fluid sensor 400. As illustrated, a fluid sensor 400 may be equipped with a beam generator (e.g., illumination source 421) and a pulse detector (e.g., photodiode element 422), each of which may be positioned within an interior portion a of a fluid sensor housing 401 of the fluid sensor 400 and along at least a portion of a fluid flow path extending within the housing 401 between the fluid sensor inlet 411 and the fluid sensor outlet 412. Additionally, the fluid sensor 400 may be configured with a photoelectric converter 423. In various embodiments, an illumination source 421 of an exemplary fluid sensor 400 may be a laser, lamp, light-emitting diode (LED), or the like, which may operate in connection with one or more lenses collectively configured to generate a light beam (e.g., ultraviolet, visible, infrared, or multiple color light) directed across the fluid flow path passing through a detection cavity of the fluid sensor 400. For example, the fluid sensor 400 may be configured to use laser-based light scattering particle sensing for detecting particles within a volume of fluid (e.g., a first fluid sample). In various embodiments, the fluid sensor 400 may comprise a fan 430 used to draw a fluid sample (e.g., at least a portion of a volume of fluid within an adjacent ambient environment) into the fluid sensor inlet 411 and through the fluid sensor 400 along a fluid flow path. Further, a fluid sensor 400 embodying a first flow sensor may comprise a first fluid flow conduit 413 configured to receive a first fluid sample comprising a first plurality of particles. As illustrated, a first fluid flow conduit 413 may be defined by a portion of a fluid flow path within an exemplary fluid sensor 400 that is positioned downstream from a first flow sensor fluid inlet 411 and/or upstream from a detection cavity. In some embodiments, the fluid may flow through the detection cavity defined at least in part by a portion of an interior portion within a fluid sensor housing 401 configured to enclose the illumination source 421 (e.g., laser, lamp, LED, or the like) such that plurality of particles or other attributes of the fluid flow may reflect at least a portion of the light generated by the illumination source 421, thereby enabling the photodiode element 422 to capture the pulses of light that are reflected off of at least a portion of the plurality of particles in the fluid sample. In some embodiments, the photodiode element 422 may transmit one or more signals including data indicative of a light reflected off of the one or more particles in the sample fluid to the photoelectric converter 423. For example, as described herein, in various embodiments, particle data captured by a first flow sensor comprising a fluid sensor, such as, for example, exemplary fluid sensor 400, may be based at least in part on the data signals received and/or processed by the photoelectric converter 423. In various embodiments, as described in further detail herein, an exemplary fluid sensor 400 may be configured to transmit one or more signals (e.g., data signals, control signals) to one or more components of the exemplary fluid flow device, such as, for example, a controller 300. It should be understood that the exemplary configuration of the fluid sensor 400 illustrated in FIG. 2 is merely an example, and various embodiments, a fluid flow device, as described herein, may incorporate fluid sensors having other configurations for detection of one or more particle characteristics.

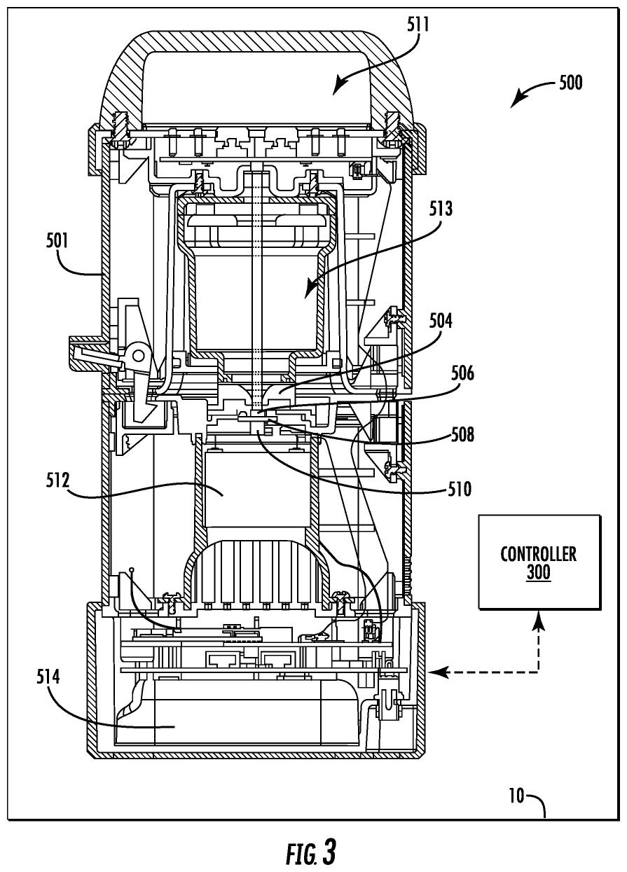

Alternatively, or additionally, in various embodiments, a first flow sensor of an exemplary fluid flow device may comprise a fluid composition sensor. For example, referring to FIG. 3, an exemplary a first fluid sample (e.g., a first plurality of particles) may be received by a fluid flow device at a first flow sensor embodied by an exemplary fluid composition sensor 500. FIG. 3 illustrates an exemplary fluid composition sensor 500 that may embody the first flow sensor of an exemplary fluid flow device, according to various embodiments. As illustrated, an exemplary fluid composition sensor 500 may comprise a particle imaging sensor. For example, first particle data associated with one or more of the first plurality of particles received by the fluid flow device may be captured by an exemplary fluid composition sensor 500. In such an exemplary circumstance, exemplary fluid composition sensor 500 may capture particle data, such as, for example, a particle image, as described herein, of the one or more particles of the first plurality of particles received by the fluid composition sensor 500. Further, in various embodiments, first particle data captured by a fluid composition sensor 500 may further comprise first particle data generated by the fluid composition sensor 500 based at least in part on the captured particle image, such as, for example, particle type data, particle matter mass concentration data, particle quantity data, particle size data, and/or the like.

As illustrated, in various non-limiting exemplary embodiments, an exemplary fluid composition sensor 500 may comprise a housing 501, an impactor nozzle 504, a collection media 506, an at least partially transparent substrate 508, and an imaging device 510. In some embodiments, the fluid composition sensor 500 may further comprise a power supply 514 configured to power the fluid composition sensor 500 and a fan or pump 512 configured to pull the volume of fluid into and through the fluid composition sensor 100. In various embodiments, the fan or pump 512 is calibrated, such that the flow rate of fluid moving through the device is known/determined based at least in part on the operating characteristics (e.g., operating power) of the fan or pump 512. In various embodiments, a fluid composition sensor 500 comprising a the collection media 506 may be configured so as to direct at least a portion of a first fluid sample received by the fluid composition sensor 500 along a fluid flow path within the sensor housing 501 in a direction perpendicular to a receiving surface of the collection media 506, such that the first fluid sample (e.g., one or more of the first plurality of particles) may interact with the collection media 506. As illustrated, a fluid composition sensor 500 embodying a first flow sensor may comprise a first fluid flow conduit 513 configured to receive a first fluid sample comprising a first plurality of particles. As illustrated, a first fluid flow conduit 513 may be defined by a portion of a fluid flow path within an exemplary fluid composition sensor 500 that is positioned downstream from a first flow sensor fluid inlet 511 and/or upstream from a collection media 506. As a non-limiting example, in various embodiments, the collection media 506 may comprise an adhesive (i.e. sticky) material, such as a gel, and may be configured to receive the one or more particles of the first plurality of particles via the interaction with the first fluid sample. In various embodiments, an exemplary fluid composition sensor 500 may have a designated field of view for capturing, permanently and/or temporarily, a particle image of at least a portion of a first plurality of particles simultaneously. For example, the collection media 506 may reside at least partially within the field of view of an imaging device 510, as described herein, such that the at least a portion of the first plurality of particles captured by the collection media 506 is visible by the imaging device 510, and first particle data comprising a particle image may be captured by the fluid composition sensor 500 (e.g., by the imaging device 510).

In various embodiments, the fluid composition sensor 500 may comprise a lens free microscope. In such an exemplary embodiment, the fluid composition sensor 500 may capture first particle data including a particle image of the one or more particles of the first plurality, by executing one or more imaging techniques, such as, for example, lensless holography, to capture the particle image. Alternatively, or additional, in various embodiments, the fluid composition sensor 500 may comprise a lens-based imaging device or any other device configured to capture a particle image that may at least partially define the first particle data, as described herein. In various embodiments, a lens-based imaging device may utilize one or more imaging techniques, such as, for example, optical microscopy, to capture a particle image of the one or more particles of the first plurality. In various embodiments, optical microscopy may comprise light transmitted through or reflected from a collection media and/or a plurality of particles disposed therein through one or more lenses to magnify and capture a particle image of at least a portion of a plurality of particles within the collection media 506. In various embodiments, as described in further detail herein, an exemplary fluid composition sensor 500 may be configured to transmit one or more signals (e.g., data signals, control signals) to one or more components of the exemplary fluid flow device, such as, for example, a controller 300. It should be understood that the exemplary configuration of the fluid composition sensor 500 illustrated in FIG. 3 is merely an example, and various embodiments, a fluid flow device, as described herein, may incorporate fluid composition sensors having other configurations for detection of one or more particle characteristics.

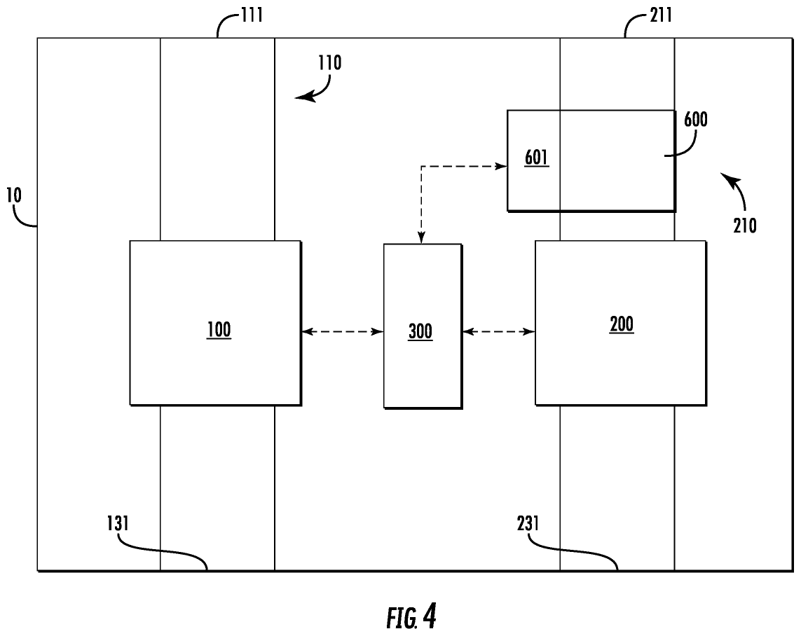

FIG. 4 illustrates an exemplary fluid flow device according to an exemplary embodiment. In particular, FIG. 4 illustrates an exemplary fluid flow device 10 comprising a plurality of fluid flow conduits, each configured to receive a respective fluid sample comprising a plurality of particles via a respective fluid inlet that may be fluidly connected with an ambient environment. As illustrated, fluid flow device 10 may comprise a first fluid flow conduit 110 configured to receive a first fluid sample via a first fluid inlet 111, and a second fluid flow conduit 210 that is configured to receive a second fluid sample via a second fluid inlet 211. In various embodiments, the first and second fluid flow conduits 110, 210 may be defined by respective portions of two fluidly distinct fluid flow paths.

In various embodiments, as illustrated in FIG. 4, an exemplary fluid flow device 10 may comprise a first flow sensor 100 and a second flow sensor 200. In various embodiments, a first flow sensor 100 may be fluidly connected to and/or may comprise a first fluid flow conduit 110 such that at least a portion of a first fluid flow path defined within the first flow sensor 100 is arranged downstream from the first fluid flow conduit 110. Similarly, in various embodiments, a second flow sensor 200 may be fluidly connected to and/or may comprise a second fluid flow conduit 210 such that at least a portion of a second fluid flow path defined within the second flow sensor 200 is arranged downstream from the second fluid flow conduit 210. Further, in various embodiments, an exemplary fluid flow device 10 may be configured such that both a first fluid sensor 100 and a second fluid sensor 200 are in electronic communication with a controller 300. For example, each of the first fluid sensor 100 and the second fluid sensor 200 may be configured to transmit and/or receive one or more signals (e.g., data signals, control signals) from and/or to the controller 300 in order to execute at least a portion of one or more operations described herein.

In various embodiments, an exemplary fluid flow device 10 may comprise a first fluid outlet 131 defined by a downstream end of a first fluid flow path that is configured to be fluidly connected to a first flow sensor 100 such that at least a portion of a first fluid sample received by the first fluid sensor 100 may be dispensed from the first fluid sensor 100 and/or from the fluid flow device 10 by flowing therethrough. Similarly, an exemplary fluid flow device 10 comprising a second flow sensor 200, as illustrated, may further comprise a second fluid outlet 231 defined by a downstream end of a second fluid flow path that is configured to be fluidly connected to a second flow sensor 200 such that at least a portion of a second fluid sample received by the second fluid sensor 200 may be dispensed from the second fluid sensor 200 and/or from the fluid flow device 10 by flowing therethrough.

In various embodiments, as described herein, exemplary fluid flow device 10, as illustrated, may comprise a flow conditioning element, such as, for example, a heating element. In various embodiments, a heating element, as described in further detail herein, may comprise one or more elements configured to generate a thermal energy that may be transferred, at least in part, such that a heat is applied to one or more of a plurality particles received by the fluid flow device 10 via a fluid sample. For example, in various embodiments, a heating element may be configured to apply heat to one or more particles present within a fluid flow conduit. Further, in various embodiments, a heating element may be configured to apply heat to one or more particles received by (e.g., disposed within) a collection media of an exemplary fluid composition sensor. In such an exemplary circumstance, an exemplary fluid composition sensor may comprise a collection media configured to receive one or more of the second plurality of particles, as described herein, that includes and/or is positioned at least substantially adjacent a heated surface that is heated by the heating element of the fluid flow device 10.

As illustrated in FIG. 4, in various embodiments, a heating element 601 may be configured to generate a thermal energy that may be transferred, at least in part, to a second fluid flow conduit (e.g., within a second flow sensor 200) configured to receive the second fluid sample comprising the second plurality of particles. For example, a heating element (e.g., heating strips, a heating sleeve, and/or the like) may apply heat to at least a portion of an outer surface of a second fluid flow conduit 210, which may be formed from an at least partially heat-conductive material, such that at least a portion of the interior of the second fluid flow conduit 210 disposed at least substantially adjacent the heating element 601 be heated. For example, a heated interior portion of a fluid flow conduit may define a heating chamber 600. As described herein, a heating chamber may be defined at least in part by a portion of a second fluid flow path along which one or more particles of the second plurality of particles within the second fluid sample may be subjected to a heated condition generated by a heating element 601. For example, in various embodiments, a heating chamber 601 may be defined by the portion of a fluid flow conduit 201 that is configured to receive a second plurality of particles within the second fluid sample flowing therethrough, and is positioned at least substantially adjacent the heating element 601. As illustrated, the heating chamber 600 may be positioned along the second fluid flow path an upstream position relative to at least a portion of the second flow sensor 200 (e.g., a detection chamber, a collection media).

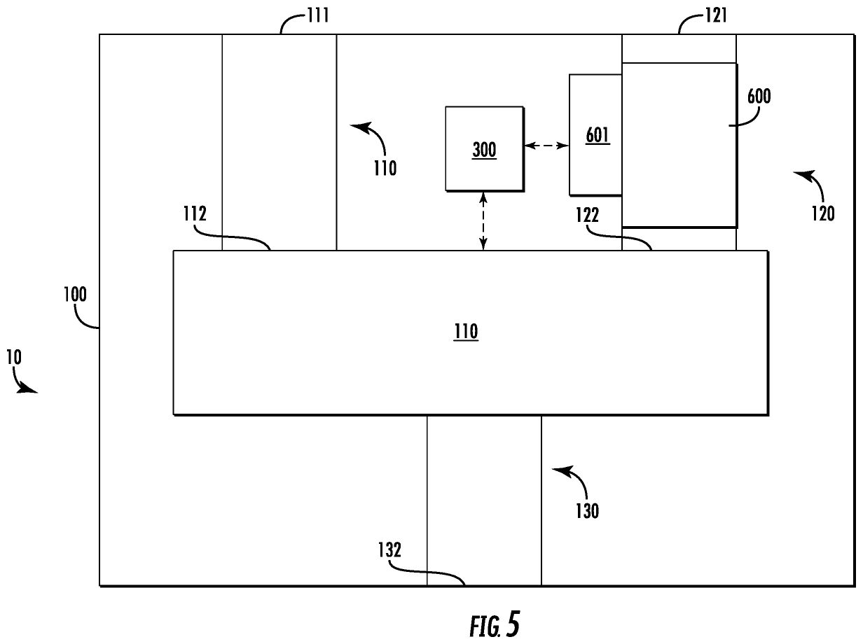

FIG. 5 illustrates an exemplary fluid flow device according to an exemplary embodiment. In particular, FIG. 5 illustrates an exemplary fluid flow device 10 that includes a first flow sensor 100 comprising a first fluid flow conduit 110 configured to receive a first fluid sample via a first fluid inlet 111, and a second fluid flow conduit 120 that is configured to receive a second fluid sample via a second fluid inlet 121. As illustrated, an exemplary fluid flow device 10 may be configured such that the first and second fluid flow conduits 110, 120, as described herein, are defined by respective portions of two fluidly distinct fluid flow paths arranged within a first flow sensor 100. In such an exemplary circumstance, an exemplary first flow sensor 100 (e.g., a fluid sensor, a fluid composition sensor) comprising a first fluid flow conduit 110 and a fluidly distinct second fluid flow conduit 120 configured to receive a first fluid sample and a second fluid sample, respectively, may be configured to selectively receive the first and second fluid samples in one or more operations that may be carried out by the first flow sensor 100 at least substantially in series. As a non-limiting example, the first flow sensor 100 illustrated in FIG. 5 may comprise a fluid composition sensor, such as, for example, the exemplary fluid composition sensor 500 described herein in reference to FIG. 3. In such an exemplary circumstance, the first flow sensor 100 may comprise one or more collection media positioned downstream from each of the first fluid flow conduit 110 and the second fluid flow conduit 120, such that the one or more collection media may interact with at least a portion of a first plurality of particles within a first fluid sample dispensed from the first fluid flow conduit 110, and at least a portion of a second plurality of particles within the second fluid sample from the second fluid flow conduit 120.

An exemplary first flow sensor 100 comprising a fluid composition sensor, as illustrated, may comprise an imaging device having a designated field of view for capturing, permanently and/or temporarily, a particle image of at least a portion of a first plurality of particles and/or a second plurality of particles either simultaneously or in series. For example, the collection media may reside at least partially within the field of view of an imaging device 110, as described herein, such that the at least a portion of the first plurality of particles and at least a portion of the second plurality of particles captured by the collection media may be visible by the imaging device 110. As described herein, first particle data comprising a first particle image of one or more of the first plurality of particles and second particle data comprising a second particle image of one or more of the second plurality of particles may be captured by the first flow sensor 100 (e.g., by the imaging device 110). In various embodiments, an exemplary first flow sensor 100 may comprise one or more fluid outlets 132 defined by a downstream end of one or more fluid flow paths that is configured to be fluidly connected to one or more of a first fluid flow conduit 110 and a second fluid flow conduit 120 such that at least a portion of a first fluid sample and a second fluid sample received by the first fluid sensor 100 may be dispensed from the first fluid sensor 100 and/or from the fluid flow device 10 by flowing therethrough.

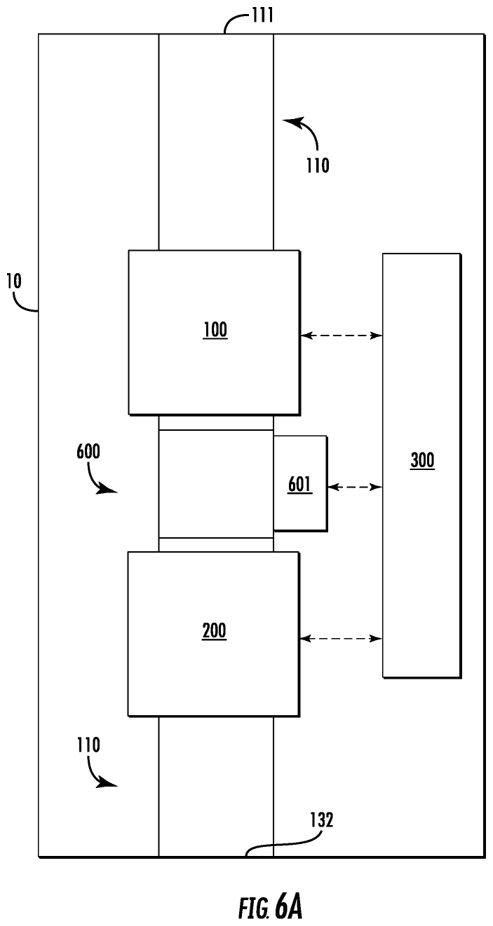

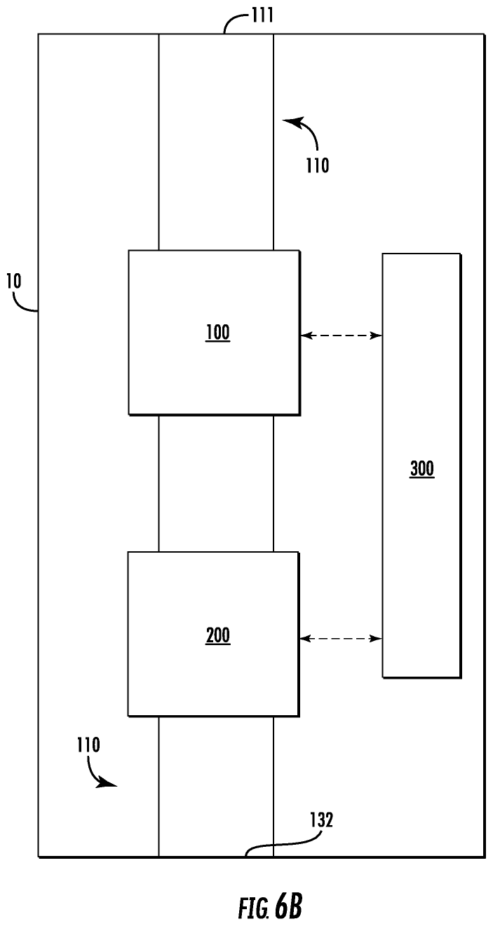

FIGS. 6A-6B illustrate an exemplary fluid flow devices according to various exemplary embodiments. In particular, FIGS. 6A-6B each illustrate an exemplary fluid flow device 10 that includes a first flow sensor 100 and a second flow sensor 200 arranged along the same fluid flow path such that the fluid flow device 10 is configured to execute one or more sequential particle data capturing operations. In various embodiments, a first flow sensor 100 and a second flow sensor 200 of an exemplary fluid flow device 10 may be arranged along the same fluid flow path, such that the second flow sensor 200 is positioned in a downstream configuration relative to the first flow sensor 100. An exemplary fluid flow device 10 may be configured such that a first fluid sample dispensed from a first flow sensor 100 may be delivered to a second fluid flow conduit 210 disposed between the first flow sensor 100 and the second flow sensor 200. For example, in such an exemplary circumstance, a first fluid sample received by the first flow sensor 100 and a second fluid sample subsequently received by the second flow sensor 200 may comprise at least substantially the fluid sample. As illustrated in FIG. 6A, the exemplary fluid flow device 10 may comprise a heating chamber 600 disposed within a fluid flow conduit portion extending between the first flow sensor 100 and the second flow sensor 200, such that the fluid sample may be selectively heated, as described herein, prior to being received by the second flow sensor 200. In such an exemplary configuration, wherein a fluid flow device 10 is configured such that a fluid sample received by the fluid flow device 10 may be sequentially received be a first flow sensor 100, a heating chamber 600, and a second flow sensor 200, each arranged in series along a fluid flow path, both the first particle data captured by the first flow sensor 100 and the and the second particle data captured by the second flow sensor 200 may be associated with the same fluid sample. For example, the first particle data captured by the first flow sensor 100 may be associated with one or more of a plurality of particles within a fluid sample, wherein the one or more particles associated with the first particle data comprise an unheated particle configuration. Further, in various embodiments, the second particle data captured by the second flow sensor 200 may be associated with one or more of a plurality of particles within the fluid sample dispensed from the upstream first flow sensor 100, wherein the one or more particles associated with the second particle data comprise a heated particle configuration. As illustrated in FIG. 6B, in various embodiments, an exemplary fluid flow device may be at least substantially free of a heating element 601 such that a heating element is not defined along the fluid flow path of the exemplary device. As a non-limiting example, an exemplary fluid flow device 10 as illustrated in FIG. 6B, may be utilized to execute one or more operations of an exemplary method 2000, as described herein.

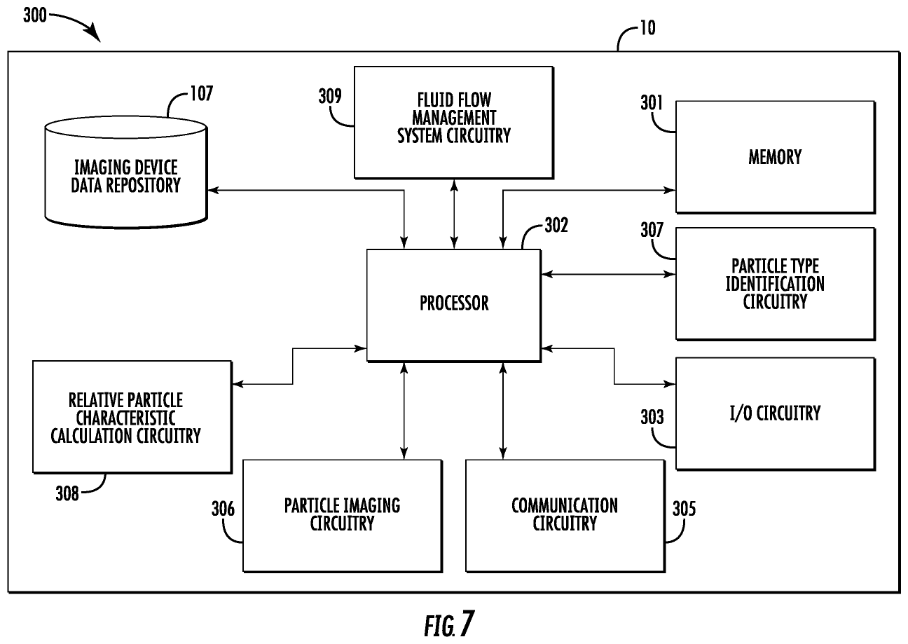

As illustrated in FIG. 7, the controller 300 may comprise a memory 301, a processor 302, input/output circuitry 303, communication circuitry 305, an imaging device data repository 107, particle imaging circuitry 306, particle type identification circuitry 307, relative particle characteristic calculation circuitry 308, and fluid flow management system circuitry 309. The controller 300 may be configured to execute the operations described herein. Although the components are described with respect to functional limitations, it should be understood that the particular implementations necessarily include the use of particular hardware. It should also be understood that certain of the components described herein may include similar or common hardware. For example, two sets of circuitry may both leverage use of the same processor, network interface, storage medium, or the like to perform their associated functions, such that duplicate hardware is not required for each set of circuitry. The use of the term “circuitry” as used herein with respect to components of the controller 200 should therefore be understood to include particular hardware configured to perform the functions associated with the particular circuitry as described herein.

The term “circuitry” should be understood broadly to include hardware and, in some embodiments, software for configuring the hardware. For example, in some embodiments, “circuitry” may include processing circuitry, storage media, network interfaces, input/output devices, and the like. In some embodiments, other elements of the controller 300 may provide or supplement the functionality of particular circuitry. For example, the processor 302 may provide processing functionality, the memory 301 may provide storage functionality, the communications circuitry 305 may provide network interface functionality, and the like.

In some embodiments, the processor 302 (and/or co-processor or any other processing circuitry assisting or otherwise associated with the processor) may be in communication with the memory 301 via a bus for passing information among components of the apparatus. The memory 301 may be non-transitory and may include, for example, one or more volatile and/or non-volatile memories. For example, the memory 301 may be an electronic storage device (e.g., a computer readable storage medium). In various embodiments, the memory 301 may be configured to store information, data, content, applications, instructions, or the like, for enabling the apparatus to carry out various functions in accordance with example embodiments of the present disclosure. It will be understood that the memory 301 may be configured to store partially or wholly any electronic information, data, data structures, embodiments, examples, figures, processes, operations, techniques, algorithms, instructions, systems, apparatuses, methods, look-up tables, or computer program products described herein, or any combination thereof. As a non-limiting example, the memory 301 may be configured to store particle size data, particle type data, particle impaction depth data, particle image data, particle shape data, particle cross-sectional area data, particle mass data, particle density data, particulate matter mass concentration data, particle quantity data, particle concentration data, particle liquid content data, relative particle characteristic data, timestamp data, location data, and/or the like, associated with a volume of fluid (e.g., a fluid sample).

The processor 302 may be embodied in a number of different ways and may, for example, include one or more processing devices configured to perform independently. Additionally or alternatively, the processor may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In an example embodiment, the processor 302 may be configured to execute instructions stored in the memory 301 or otherwise accessible to the processor. Alternatively, or additionally, the processor may be configured to execute hard-coded functionality. As such, whether configured by hardware or software methods, or by a combination thereof, the processor may represent an entity (e.g., physically embodied in circuitry) capable of performing operations according to an embodiment of the present disclosure while configured accordingly. Alternatively, as another example, when the processor is embodied as an executor of software instructions, the instructions may specifically configure the processor to perform the algorithms and/or operations described herein when the instructions are executed.

In some embodiments, the controller 300 may include input-output circuitry 303 that may, in turn, be in communication with the processor 302 to provide output to the user and, in some embodiments, to receive input such as a command provided by the user. The input-output circuitry 303 may comprise a user interface, such as a graphical user interface (GUI), and may include a display that may include a web user interface, a GUI application, a mobile application, a client device, or any other suitable hardware or software. In some embodiments, the input-output circuitry 303 may also include a display device, a display screen, user input elements, such as a touch screen, touch areas, soft keys, a keyboard, a mouse, a microphone, a speaker (e.g., a buzzer), a light emitting device (e.g., a red light emitting diode (LED), a green LED, a blue LED, a white LED, an infrared (IR) LED, or a combination thereof), or other input-output mechanisms. The processor 302, input-output circuitry 303 (which may utilize the processing circuitry), or both may be configured to control one or more functions of one or more user interface elements through computer-executable program code instructions (e.g., software, firmware) stored in a non-transitory computer-readable storage medium (e.g., memory 301). Input-output circuitry 303 is optional and, in some embodiments, the controller 300 may not include input-output circuitry. For example, where the controller 300 does not interact directly with the user, the controller 300 may generate user interface data for display by one or more other devices with which one or more users directly interact and transmit the generated user interface data to one or more of those devices. For example, the controller 300, using user interface circuitry may generate user interface data for display by one or more display devices and transmit the generated user interface data to those display devices.

The communications circuitry 305 may be a device or circuitry embodied in either hardware or a combination of hardware and software that is configured to receive and/or transmit data from/to a network and/or any other device, circuitry, or module in communication with the apparatus 300. For example, the communications circuitry 305 may be configured to communicate with one or more computing devices via wired (e.g., USB) or wireless (e.g., Bluetooth, Wi-Fi, cellular, and/or the like) communication protocols. For example, as described in further detail herein, the communications circuitry 305 may be configured to facilitate communication between an exemplary fluid flow device and one or more computing devices of an exemplary fluid flow management system via wired (e.g., USB, ethernet, and/or the like) or wireless (e.g., Bluetooth, Wi-Fi, cellular, and/or the like) communication protocols, as described in further detail herein.

In various embodiments, the processor 302 may be configured to communicate with the particle imaging circuitry 306. The particle imaging circuitry 306 may be a device and/or circuitry embodied in either hardware or a combination of hardware and software that is configured to receive, process, generate, and/or transmit data (e.g., particle data), such as a particle image captured by an exemplary fluid composition sensor (e.g., via an imaging device 110). In various embodiments, the particle imaging circuitry 306 may be further configured to analyze one or more images captured by the imaging device 110 of the fluid composition sensor 100 to determine one or more particle characteristics, such as, for example, a particle size, particle mass matter concentration, particle quantity, particle density, and/or the like, associated with at least a portion of the one or more particles of a plurality of particles received by the fluid composition sensor (e.g., at a collection media) from a fluid sample. In various embodiments, a particle size of a particle may be defined by the cross-sectional area of the particle. In various embodiments, the particle imaging circuitry 306 may be configured to determine the particle size of particles with any of a variety of particle sizes. As an example, the particle imaging circuitry 306 may be configured to determine particle sizes of particles having a diameter of between about 0.3 and about 200 microns (e.g., 2.5 microns), and thus, a size category with which the particle may be associated, such as, for example, PM10, PM4, PM2.5, or PM1. In various embodiments, the controller 300 and/or the particle imaging circuitry 306 may be further configured to analyze particle data comprising one or more images captured by an imaging device of the fluid composition sensor to determine a particle concentration defined by the one or more particles of the plurality of particles disposed at (e.g., within) a collection media of an exemplary fluid composition sensor. The particle imaging circuitry 306 may be further configured to determine a particle impaction depth of at least a portion of a plurality of particles embedded within a collection media using one or more image focusing techniques. The particle imaging circuitry 306 may be configured to execute instructions stored, for example, in the memory 301 for carrying out the one or more image focusing techniques. In various embodiments, the one or more image focusing techniques may comprise one or computational techniques, such as, for example, Angular Spectrum Propagation (ASP) or machine learning (ML).

In various embodiments, the particle imaging circuitry 306 may send and/or receive data from an imaging device data repository 107. In various embodiments, the particle imaging circuitry 306 may be configured to determine one or more particle characteristics of one or more particles, as described herein, using one or more machine learning techniques. In various embodiments, the one or more machine learning techniques used by the particle imaging circuitry 306 to determine the one or more particle characteristics of one or more particles may comprise using deep supervised learning with one or more labeled datasets of one or more known particle characteristics, such as, for example, particle type, particle velocity, particle size, particle shape, particle concentration, particle quantity, particle mass matter concentration, and/or any other data generated, transmitted, and/or received by the controller 300 to estimate the one or more particle characteristics of the one or more particles. In various embodiments, the particle imaging circuitry 306 may be configured to analyze particle data comprising a captured particle image to identify a liquid particle portion within one or more particles of a plurality. For example, in an exemplary embodiment wherein a particle of a plurality disposed at a collection media comprises a liquid particle portion and a solid particle portion, particle imaging circuitry 306 may be configured to identify one or both of the liquid particle portion and/or the solid particle portion so as to distinguish between the two particle portions. As a non-limiting example, in various embodiments, particle imaging circuitry 306 may be configured to identify a liquid particle portion of a particle disposed within a collection media based at least in part on an index of refraction or transparency exhibited by the liquid particle portion.

Further, in various embodiments, the particle imaging circuitry 306 may be configured to analyze particle data comprising one or more images captured by the fluid composition sensor of a fluid flow device (e.g., via an imaging device 110) to determine which particles of the plurality of particles present within a collection media were newly received by the collection media during a recent particle analysis operation. The particle imaging circuitry 306 may receive from the imaging device, for example, a first captured particle image and a second captured particle image, captured at a first time and a second time, respectively, wherein the first time represents the start of an analysis of the one or more particles of the plurality of particles captured by the collection media by the fluid flow device 10 and the second time is subsequent the first time (occurs after the first time). In such a configuration, the fluid flow device 10 may be configured to distinguish between particles present within the collection media at the start of a particle analysis and particles that were newly received by the collection media by comparing the respective particle images captured at the first and second times and identifying any particles from the second captured particle image that were not captured in the first captured particle image.

In various embodiments, the processor 302 may be configured to communicate with the particle type identification circuitry 307. The particle type identification circuitry 307 may be a device or circuitry embodied in either hardware or a combination of hardware and software that is configured to identify a particle type and/or particle species of one or more particles of the plurality of particles received by a collection media of an exemplary fluid composition sensor. In various embodiments, a plurality of particles within a fluid sample received by the fluid composition sensor (e.g., within a volume of fluid) may comprise one or more particles of various particle types, such as, for example, one or more of bacteria, pollen, spores, molds, biological particles, soot, inorganic particles, organic particles, and droplets. In various embodiments, the particle type identification circuitry 307 may determine the particle type and/or particle species of each of the one or more particles of the plurality of particles received by the collection media using one or more machine learning techniques. In various embodiments, the one or more machine learning techniques used by the particle type identification circuitry 307 to determine the particle type and/or species of each of the one or more particles of the plurality of particles may comprise analyzing particle data comprising a particle image captured by an imaging device, particle size data, particle shape data, particle concentration data, particle quantity data, particle mass matter concentration data, and/or any other data generated, transmitted, and/or received by the controller 300. In various embodiments, the particle type identification circuitry 307 may send and/or receive data from the imaging device data repository 107.

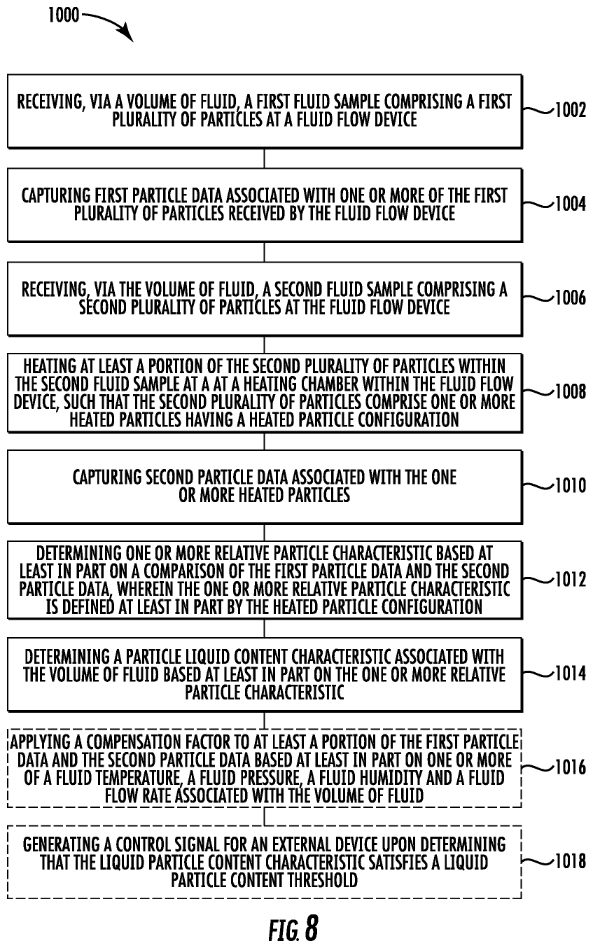

The relative particle characteristic calculation circuitry 308 may be a device or circuitry embodied in either hardware or a combination of hardware and software that is configured to determine one or more relative particle characteristic based at least in part on a comparison of the first particle data and the second particle data. For example, the relative particle characteristic calculation circuitry 308 may be configured to compare at least a portion of first particle data associated with a first flow sensor and/or a first fluid sample to corresponding second particle data associated with a second flow sensor and/or a second fluid sample. In various embodiments, such as, for example, in an exemplary embodiment described herein in reference to exemplary method 1000 illustrated at FIG. 8, at least a portion of the first particle data associated with a first fluid sample (e.g., an unheated fluid sample) may be compared relative particle characteristic calculation circuitry 308 to at least a portion of the second particle data associated with a second fluid sample (e.g., a heated sample comprising one or more heated particles) in order to identify, determine, characterize, and/or calculate one or more relative particle characteristics associated with both the first fluid sample and the second fluid sample. For example, as described herein, in various embodiments, both the first and second pluralities of particles may be made up of a plurality of particles that each comprise a liquid particle portion and a solid particle portion. In various embodiments, the second particle data associated with one or more heated particle from the second plurality of particles may define at least one particle characteristic associated with the heated particle that is at least substantially different from a corresponding particle characteristic associated with the one or more of the first plurality of particles from the first fluid sample (e.g., an unheated sample).

In various embodiments, relative particle characteristic calculation circuitry 308 may be configured to identify a relative particle characteristic as being a difference between a first particle characteristic defined by first particle data and a second particle characteristic defined by second particle data. In such an exemplary circumstance, the relative particle characteristic calculation circuitry 308 may be configured to programmatically determine the relative particle characteristic based at least in part on the equation below:

Difference=α[Second Particle Characteristic]−β[First Particle Characteristic]

Further, in various embodiments, relative particle characteristic calculation circuitry 308 may be configured to identify a relative particle characteristic as being a ratio of a second particle characteristic defined by second particle data to a first particle characteristic defined by first particle data. In such an exemplary circumstance, the relative particle characteristic calculation circuitry 308 may be configured to programmatically determine the relative particle characteristic based at least in part on the equation below:

$$Ratio = γ \frac{[ Second Particle Characteristic ]}{[ First Particle Characteristic ]}$$

In various embodiments, the relative particle characteristic calculation circuitry 308 may be configured to retrieve data comprising one or more sensor calibration factors (e.g., α, β, γ) from a memory 301.

In various embodiments, the processor 302 may be configured to communicate with the fluid flow system management circuitry 309. The fluid flow system management circuitry 309 may be a device or circuitry embodied in either hardware or a combination of hardware and software that is configured to determine that a particle liquid content characteristic associated with a fluid sample satisfies a particle liquid content threshold value. In various embodiments, upon determining that the particle liquid content characteristic satisfies the particle liquid content threshold value, the fluid flow system management circuitry 309 may be configured to generate a control signal for transmission to second system device of a fluid flow monitoring system, such as, for example, a management computing entity 40. Further, in various embodiments, the fluid flow system management circuitry 309 may generate one or more additional signals for transmission to one or more components of the fluid flow system management system, as described herein, to facilitate one or more fluid flow monitoring operations and/or various responsive mitigating operations.

In various embodiments, an exemplary fluid flow device 10 may be configured with, or in communication with, an imaging device data repository 107. The imaging device data repository 107 may be stored, at least partially on the memory 301 of the system. In some embodiments, the imaging device data repository 107 may be remote from, but in connection with, the device 10. The imaging device data repository 107 may contain information, such as images relating to one or more potential components of fluids. In some embodiments, the imaging device data repository 107, and/or other similar reference databases in communication with the device 10, may comprise non-image information used to identify particles (e.g., for florescent particles, a spectrometer may be used by the fluid composition sensor 100 as discussed herein and the device 10 may receive spectrum information to identify and/or classify the particles). In some embodiments, the device 10 may also use machine learning for identifying and/or classifying particles, such that the device 10 may use a reference database, such as the imaging device data repository 107, to initially train the device 10 and then may be configured to identify and/or classify particles without referencing the imaging device data repository 107 or other reference databases (e.g., a system may not be in active communication with the imaging device data repository 107 during regular operations).

In various embodiments, one or more flow sensors (e.g., a first flow sensor 100, a second flow sensor 200) of an exemplary fluid flow device 10 may comprise a fluid composition sensor comprising a particle imaging sensor. A fluid composition sensor may be configured to detect, measure, characterize, and/or identify one or more particles within a volume of fluid, as described herein, based at least in part on an image of the one or more particles. For example, an exemplary flow sensor comprising a fluid composition sensor may be configured to capture an image of one or more particles of a plurality of particles present within a received volume of fluid. In various embodiments, the fluid composition sensor may comprise a lens free microscope, configured to capture a particle image of the one or more particles within a fluid sample received by a fluid flow device utilizing one or more particle imaging techniques, such as, for example, lensless holography. Further, in various embodiments, a fluid composition sensor may comprise a lens-based imaging device or any other device configured to capture an image that may be analyzed, as described herein, to determine one or more particle characteristics of the one or more imaged particles. For example, a lens-based imaging device may utilize one or more particle imaging techniques, such as, for example, optical microscopy, to capture a particle image of the one or more particles within a fluid sample received by a fluid flow device. In various embodiments, as described in further detail herein, optical microscopy may comprise light transmitted through or reflected from a collection media and/or a plurality of particles disposed therein through one or more lenses to magnify and capture an image of at least a portion of the one or more of the particles within the collection media. As a non-limiting example, in certain embodiments, the fluid sensor may be embodied as a fluid (e.g., air) composition sensor comprising a Honeywell Air Detective Sensor and/or any other suitable devices capable of measuring particle content within one or more volumes of fluid using one or more particle imaging operations. As further non-limiting examples, a fluid composition sensor may be embodied as a UV fluorescence system, a traditional microscope, Burkard samplers and traps, Allergenco sampler and greased slide, and/or the like. In various embodiments, an exemplary fluid composition sensor may comprise and/or be utilized in combination with a processor configured for generating various control signals, as described herein.

In various embodiments, as described in further detail herein, an exemplary flow sensor, such as, for example a fluid sensor and/or a fluid composition sensor, may be configured to receive one or more volumes of fluid defining a plurality of fluid samples. For example, a fluid sensor (e.g., a first fluid sensor 100, a second fluid sensor 200) of an exemplary fluid flow device 10 may receive a first fluid sample comprising a first plurality of particles and a second fluid sample comprising a second plurality of particles. In various embodiments, an exemplary flow sensor may comprise a first fluid flow conduit configured to receive the first fluid sample and a second fluid flow conduit configured to receive the second fluid sample. As described herein, an exemplary fluid flow device comprising a first fluid flow conduit and a second fluid flow conduit may further comprise a flow conditioning element, such as, for example, a heating element. For example, the flow conditioning element may be arranged at least substantially adjacent a second fluid flow conduit and configured to selectively condition at least a portion of the particles within the second fluid sample as the second fluid sample is disposed within the second fluid flow conduit. In such an exemplary circumstance, an exemplary fluid flow device may be configured to generate and/or process particle data including, for example, a liquid-to-solid particle content ratio, a liquid particle portion volume, and/or the like, associated with one or both of the first fluid sample and the second fluid sample based at least in part on a comparison between a first measured particle characteristic from the first fluid sample (e.g., an unconditioned fluid sample) and a second measured particle characteristic from the second fluid sample (e.g., a conditioned fluid sample).

As described herein, in various embodiments, as described herein, an exemplary fluid flow device configured to receive at least a portion of a volume of fluid from an ambient environment may be configured to determine a particle liquid content characteristic associated with the volume of fluid based at least in part on captured particle data associated with one or more fluid samples received, via the volume of fluid, by the fluid flow device. For example, referring now to FIG. 8, a flowchart of an exemplary method 1000 for determining a particle liquid content characteristic associated with a volume of fluid is provided. In some embodiments, one or more operations of the illustrated exemplary method 1000 may be executed by controlling a fluid flow device in accordance with one or more example embodiments described herein. For example, various operations discussed below with respect to exemplary method 1000 may be carried out using various components of an exemplary fluid flow device, such as, for example, an exemplary fluid flow device 10 as described above in reference to FIG. 1. In various embodiments, an exemplary fluid flow device utilized to execute one or more operations of exemplary method 1000 may comprise a controller, including one or more processors, a first flow sensor, and a flow conditioning element. In various embodiments, the first fluid flow sensor may comprise either a fluid sensor or a fluid composition sensor, as described herein. Further, in various embodiments, an exemplary fluid flow device utilized to execute one or more operations of exemplary method 1000 may further comprise a second flow sensor, may comprise either a fluid sensor or a fluid composition sensor. In various embodiments, the exemplary fluid flow device may be in communication with one or more external devices, such that a control signal generated by the fluid flow device may be transmitted to the one or more external devices. Various components referenced in relation to the exemplary fluid flow device may be included with or in communication with the fluid flow device.

As illustrated in FIG. 8, exemplary method 1000, at Block 1002, may include receiving, via a volume of fluid, a first fluid sample comprising a first plurality of particles at a fluid flow device. In various embodiments, the first fluid sample may embody a first sample volume of fluid that defines at least a portion of the volume of fluid and comprises the first plurality of particles. In various embodiments, the volume of fluid defined in part by the first fluid sample may correspond to a fluid within an ambient environment, such that the particles present within a sample fluid from the volume of fluid (e.g., the first fluid sample) may be defined by one or more particle characteristics that are at least substantially similar to a particle characteristic of the fluid within the ambient environment. For example, in various embodiments, the first plurality of particles received by an exemplary fluid flow device may be representative of a plurality of particles present within the fluid within the ambient environment.

Further, at Block 1004, first particle data associated with one or more of the first plurality of particles received by the fluid flow device may be captured. In various embodiments, as described herein, first particle data associated with a first fluid sample may be captured by a first flow sensor 100. In various embodiments, the first plurality of particles within the first fluid sample may be received by the first flow sensor 100 configured to receive the first fluid sample. For example, the first fluid sample may be received at a first fluid flow conduit of the first flow sensor 100. In various embodiments, an exemplary first flow sensor 100 may be configured such that the first fluid flow conduit is arranged downstream from a first flow sensor fluid inlet and/or upstream from a detection cavity. For example, the first fluid sample (e.g., the first plurality of particles) may travel from the first flow sensor fluid inlet of the first flow sensor 100 to the first fluid flow conduit, and, further, may travel along the first fluid flow conduit, such that the first fluid flow conduit defines at least a portion of the fluid flow path of the first fluid sample.

Referring now to Block 1006 of FIG. 8, exemplary method 1000 may include receiving, via the volume of fluid, a second fluid sample comprising a second plurality of particles at a fluid flow device. In various embodiments, the second fluid sample may embody a second sample volume of fluid that defines at least a portion of the volume of fluid and comprises the second plurality of particles. In various embodiments, the volume of fluid defined in part by the second fluid sample may be at least substantially the same volume of fluid within the ambient environment that is defined in part by the first fluid sample, as described herein. In such an exemplary circumstance, the second plurality of particles present within the second fluid sample from the volume of fluid may be defined by one or more particle characteristics that are at least substantially similar to a particle characteristic of the fluid within the ambient environment. For example, in various embodiments, the second plurality of particles received by an exemplary fluid flow device may be at least partially representative of a plurality of particles present within the fluid (e.g., air) of the ambient environment.

In various embodiments, the second fluid sample comprising the second plurality of particles may be received by a fluid flow device at the first flow sensor 100. For example, in various embodiments, the exemplary first flow sensor 100 configured to receive the first fluid sample may comprise a plurality of fluid flow conduits, each defining at least a portion of a respective, fluidly distinct fluid flow paths, including a first fluid flow conduit configured to receive the first fluid sample, as described above, and a second fluid flow conduit configured to receive the second fluid sample. For example, such an exemplary configuration is described herein with respect to the exemplary flow sensor 100 illustrated in FIG. 5. In such an exemplary circumstance, an exemplary first flow sensor 100 (e.g., a fluid sensor, a fluid composition sensor) comprising fluidly distinct first and second fluid flow conduits configured to receive a first fluid sample and a second fluid sample, respectively, may be configured to selectively receive the first and second fluid samples in respective operations that may be carried out at least substantially simultaneously and/or in series.

By way of further non-limiting example, in various embodiments, the first flow sensor 100 may be configured to receive both the first fluid sample and the second fluid sample at the same first fluid flow conduit. In such an exemplary circumstance, a fluid flow device may comprise a single flow sensor, such as, for example, an exemplary first flow sensor 100 comprising a single fluid flow conduit configured to receive both the first and second fluid samples, as described herein. For example, the first flow sensor 100 may be configured to selectively receive the first fluid sample and the second fluid sample in respective operations that may be carried out in series. In various embodiments, for example, the first flow sensor 100 may initially receive the first fluid sample at the first fluid flow conduit, and, subsequent to the first fluid sample exiting the first fluid flow conduit (e.g., subsequent to the first fluid sample exiting the first flow sensor 100), the first flow sensor 100 may subsequently receive the second fluid sample at the first fluid flow conduit. In such an exemplary configuration, as described in further detail herein with respect to Block 1008, the fluid flow device may be configured to selectively execute one or more heating operations (e.g., via a heating element) such that at least a portion of the second plurality of particles present within the second fluid sample is heated within the first flow sensor.

Alternatively, or additionally, the second fluid sample comprising the second plurality of particles may be received by an exemplary fluid flow device 10 at a second flow sensor 200. In various embodiments, an exemplary fluid flow device 10 may comprise a first fluid sensor 100 and a second flow sensor 200. For example, such an exemplary configuration is described herein with respect to the exemplary fluid flow device 10 illustrated in FIG. 4. For example, wherein the fluid flow device 10 comprises a first and a second flow sensor, the first flow sensor 100 may be configured to receive the first fluid sample comprising the first plurality of particles and the second flow sensor 200 may be configured to receive the second fluid sample comprising the second plurality of particles. For example, a second flow sensor 200 may comprise either a fluid sensor (e.g., fluid sensor 400) or a fluid composition sensor (e.g., fluid composition sensor 500), as described herein with respect to the first flow sensor 100. In certain embodiments, wherein an exemplary fluid flow device comprises a first flow sensor 100 and a second flow sensor 200, the first and second flow sensors 100, 200 may comprise the same sensor type, such that both the first flow sensor 100 and the second flow sensor 200 comprise a fluid sensor (e.g., fluid sensor 400) or, alternatively, both sensors 100, 200 comprise a fluid composition sensor (e.g., fluid composition sensor 500). Alternatively, an exemplary fluid flow device may comprise first and second flow sensors 100, 200 that comprise different sensor types, such that one of the first flow sensor 100 and the second flow sensor 200 comprises a fluid sensor, while the other comprises a fluid composition sensor.

Referring now to Block 1008, at least a portion of the second plurality of particles within the second fluid sample may be heated, such that the second plurality of particles comprises one or more heated particles having a heated particle configuration. In various embodiments, heat may be applied to one or more of a plurality of particles received by a fluid flow device via a fluid sample. For example, in various embodiments, a heating element may be configured to apply heat to one or more particles present within a fluid flow conduit. For example, in various embodiments, heat may be applied to a fluid flow conduit within a fluid flow device (e.g., within a first flow sensor and/or a second flow sensor) that is configured to receive the second fluid sample. In such an exemplary circumstance, the at least a portion of the fluid flow conduit to which heat is applied may define a heating chamber within which heat may be applied to at least a portion of a plurality of particles passing therethrough. Alternatively, or additionally, in various embodiments, heat may be applied to a collection media disposed within an exemplary fluid composition sensor and configured to be engaged by the second fluid sample, as described herein. In such an exemplary circumstance, heat may be applied to a collection media configured to receive at least at portion of the second plurality of particles from the second fluid sample via a heating element (e.g., a heated surface) positioned at least substantially adjacent thereto, so as to heat one or more of the second plurality of particles received by the collection media.

In various embodiments, as described herein, an exemplary fluid flow device may comprise a flow conditioning element, such as, for example, a heating element. In various embodiments, a heating element may be configured to generate a thermal energy that may be transferred, at least in part, to a fluid flow conduit within a flow sensor (e.g., a first flow sensor 100, a second flow sensor 200) in order to apply heat to one or more particles present within the fluid flow conduit. For example, in various embodiments, a heating element may comprise a resistive heater (e.g., a resistive metal mesh), an electromagnetic heater (e.g., a microwave), solid-state thermoelectric heat exchanger, a counter-flow shell-and-tube heat exchanger, a plate heat exchanger, a plate and shell heat exchanger, an adiabatic wheel heat exchanger, a plate fin heat exchanger, a pillow plate heat exchanger, an optical heater, and/or the like, or any suitable combination thereof.

In various embodiments, an exemplary fluid flow device (e.g., a first flow sensor 100 or a second flow sensor 200, as described herein) may comprise a heating chamber that is defined at least in part by a portion of a fluid flow path along which a particle within a fluid sample may be subjected to a heated condition generated by a heating element. For example, in various embodiments, a heating chamber may be defined by the portion of a fluid flow conduit that is configured to receive a plurality of particles within a fluid sample flowing therethrough, and is positioned at least substantially adjacent the heating element. As a non-limiting example, in various embodiments wherein a fluid flow device comprises a first flow sensor 100 configured to receive a first fluid sample and a second flow sensor 200 configured to receive a second fluid sample, the fluid flow device may comprise a heating element configured to apply a predetermined amount of heat to a second fluid flow conduit within the second flow sensor, wherein the second fluid flow conduit comprises a portion of a fluid flow path positioned upstream from a detection/imaging device within the second flow sensor, as described herein. For example, the heating element may be arranged at least substantially adjacent an outer surface of the second fluid flow conduit. In such an exemplary circumstance, the heating chamber of the fluid flow device is defined within the second fluid flow conduit. Alternatively, or additionally, as a further non-limiting example, in various embodiments wherein a fluid flow device is configured to receive both a first fluid sample and a second fluid sample at a first flow sensor 100 via a first fluid conduit, the heating element may apply a predetermined amount of heat to the first fluid flow conduit within the first flow sensor 100, wherein the first fluid flow conduit comprises a portion of a fluid flow path positioned upstream from a detection/imaging device within the first flow sensor, as described herein. In such an exemplary circumstance, the heating chamber of the fluid flow device is defined within the first fluid flow conduit, and, further, the conditioning element (e.g., heating element) may selectively initiate one or more heating operations (e.g., based at least in part on a signal comprising one or more executable instructions) after at least substantially all of a first fluid sample has passed through the first fluid flow conduit, such that the heating chamber exhibits a heated condition upon receiving the second fluid sample. In various embodiments, a heating element of an exemplary fluid flow device (e.g., a heating chamber, a heated surface, and/or the like), as described herein, may be configured according to a heating element configuration that is defined at least in part by one or more dimensional characteristics (e.g., length, cross-sectional surface area, and/or the like) and/or one or more operational characteristics (e.g., power, duty cycle, heating element type, and/or the like). In various embodiments, the heating element configuration of an exemplary heating element may be configured to generate an amount of heat sufficient to cause at least at least a portion (e.g., at least substantially all) of the liquid content within a fluid sample to evaporate.

In various embodiments, an exemplary fluid flow device may be configured such that the particles within a second plurality of particles present with a second fluid sample, as described herein, may each embody a heated particle configuration upon exiting (e.g., flowing through) a heating chamber. In various embodiments, a heated particle configuration may be defined at least in part by one or more heated particle characteristics. As described herein, a particle may comprise a liquid particle portion and a solid particle portion, defined by liquid content and solid content, respectively, that makes up the particle. As non-limiting illustrative examples, liquid content of a particle may comprise a variety of at least partially liquid substances such as, for example mucus, saliva, electrolytes, proteins, pathogens, water, one or more volatile liquids, and/or the like. As further non-limiting illustrative examples, solid content of a particle may include various at least partially solid substances such as, for example, one or more of bacteria, pollen, spores, molds, biological particles, soot, inorganic particles, organic particles, and/or the like. In various embodiments, applying a heat to one or more particles may cause at least a portion of the liquid content within one or more particles (e.g., a liquid particle portion) to evaporate. Accordingly, in various embodiments, a heated particle configuration may be defined at least in part on one or more particle characteristics (e.g., heated particle characteristics) corresponding to a decrease in liquid content within one or more particles and/or a decrease in a liquid-to-solid particle content ratio within a particle, as defined by the ratio of the volume, make, and/or the like of a liquid particle portion within a particle to that of a corresponding solid particle portion of the particle. In various embodiments, a heated particle configuration may correspond at least in part to one or more controlled local conditions within the heating chamber, such as, for example, a chamber temperature, chamber humidity, chamber flow rate, chamber pressure, and/or the like.

As described herein, in various embodiments, an exemplary heating element may be in electronic communication with a controller 300 and may be configured to receive one or more electronic signals comprising executable instructions to initiate and/or conclude a heating operation, so as to selectively condition at least a portion of the second plurality of particles within the second fluid sample as the second fluid sample is present within a heating chamber. In various embodiments, upon heating the one or more particles of the second plurality of particles so as to provide one or more heated particles, a fluid conditioning element within the fluid flow device may be configured to cool at least a portion of the fluid flow device to an at least substantially ambient temperature. For example, such an exemplary cooling operation may be selectively executed by a fluid flow device via a fluid conditioning element (e.g., a cooling element) comprising a thermoelectric heat exchanger (e.g., a Peltier cooler), a thermo-coupled configuration utilizing a coolant fluid, a thermo-coupled configuration utilizing the ambient environment, and/or the like.

Referring now to Block 1010, exemplary method 1000 may include capturing second particle data associated with the one or more heated particles. As described herein, second particle data may comprise particle data associated with one or more of the second plurality of particles received by the fluid flow device from within the second fluid sample, the one or more of the second plurality of particles having flowed along a fluid flow path through a heating chamber of the fluid flow device so as to be defined at least in part by a heated particle configuration. In various embodiments, second particle data may be captured by a flow sensor within the fluid flow device that is configured to receive the second plurality of particles, such as, for example, the one or more heated particles. For example, wherein an exemplary fluid flow device comprises a second flow sensor 200 fluidly connected to, and/or comprises, the heating chamber of the fluid flow device and configured to receive the second fluid sample, as described herein with respect to various non-limiting, illustrative embodiments, second particle data may be captured by the second flow sensor 200. Alternatively, or additionally, the second particle data may be captured by a first flow sensor 100 in an exemplary embodiment wherein the first flow sensor 100 is fluidly connected to, and/or comprises, the heating chamber of the fluid flow device and configured to receive the second fluid sample.

As described above in reference to Block 1004, including one or more operations wherein first particle data associated with a first plurality of particles within a first fluid sample is captured by an exemplary fluid flow device, second particle data may be captured by a flow sensor comprising either a fluid sensor (e.g., fluid sensor 400) or a fluid composition sensor (e.g., fluid composition sensor 500). For example, in an exemplary circumstance wherein the one or more heated particles are received by a flow sensor comprising a fluid sensor, such as, for example, exemplary fluid sensor 400, the fluid sensor may capture second particle data, such as, for example, particle matter mass concentration data, particle quantity data, particle size data, and/or the like, associated with the one or more heated particles within the second fluid sample by utilizing a particle detector comprising a light beam generator and a pulse detector, collectively configured to monitor signal pulses generated at the pulse detector based upon the presence of the one or more particles within the exemplary fluid sensor.

Further, in an alternative embodiment wherein the one or more heated particles are received by a flow sensor comprising a fluid composition sensor such that second particle data is captured by an exemplary fluid composition sensor, such as, for example, fluid composition sensor 500, the second particle data may comprise, for example, a particle image (e.g., a second particle image). For example, second particle data comprising a second particle image may include an image of the one or more heated particles received by the exemplary fluid composition sensor. Further, in various embodiments, second particle data captured by a fluid composition sensor may further comprise second particle data generated by the fluid composition sensor based at least in part on the captured second particle image, such as, for example, particle type data, particle matter mass concentration data, particle quantity data, particle size data, and/or the like. In various embodiments, the second particle data may be based at least in part on the heated particle configuration exhibited by the one or more heated particles.

Referring now to Block 1012 of FIG. 8, exemplary method 1000 may include determining one or more relative particle characteristic based at least in part on a comparison of the first particle data and the second particle data. For example, in various embodiments, the one or more relative particle characteristic may be defined at least in part by the heated particle configuration exhibited by the one or more heated particles. In various embodiments, a relative particle characteristic may comprise one or more comparative data, images, particle characteristics, and/or the like that defines a first particle characteristic associated with the first fluid sample relative to a corresponding second particle characteristic associated with the second fluid sample. For example, a relative particle characteristic may comprise a comparison of one or more particles of the first plurality in the first fluid sample to one or more particles of the second plurality in the second fluid sample, such that a relative particle characteristic may define one or more relationships, differences, similarities, evolutions, and/or the like between the first plurality of particles and the second plurality of particles.

In various embodiments, at least a portion of the first particle data associated with a first fluid sample (e.g., an unheated sample) may be compared to at least a portion of the second particle data associated with a second fluid sample (e.g., a heated sample comprising one or more heated particles) in order to identify, determine, characterize, and/or calculate a relative particle characteristic associated with both the first fluid sample and the second fluid sample. For example, as described herein, in various embodiments, both the first and second pluralities of particles may be made up of a plurality of particles that each comprise a liquid particle portion and a solid particle portion. In various embodiments, the second particle data associated with one or more heated particle from the second plurality of particles may define at least one particle characteristic associated with the heated particle that is at least substantially different from a corresponding particle characteristic associated with the one or more of the first plurality of particles from the first fluid sample (e.g., an unheated sample) based at least in part on an at least partial evaporation the particle liquid content within the one or more heated particle. For example, in various embodiments, an at least partial evaporation of the liquid particle portion caused by an exposure of one or more of the second plurality of particles to an amount of heat within a heating chamber, as described herein, may affect a change in one or more of a particle matter mass concentration, particle quantity, particle size, a particle relative abundance, and/or the like, associated with one or more of the heated particles. In various embodiments, an amount and/or rate of evaporation exhibited by a liquid particle portion of one of the heated particles from the second fluid sample may be based at least in part on a heated particle configuration, which may correspond at least in part to one or more controlled local conditions within an exemplary heating chamber, such as, for example, a chamber temperature, chamber humidity, chamber flow rate, chamber pressure, and/or the like.

In particular, in various embodiments, an at least partial evaporation of a liquid particle portion of the one or more heated particles may result in a decrease in the particle matter mass concentration and/or particle quantity associated with one or more of the heated particles. As a non-limiting example, in various embodiments, as the liquid particle portion of a heated particle evaporates, the particle size of the heated particle (e.g., particle cross-sectional area, particle diameter, particle size category) may decrease. Further, in such an exemplary circumstance, the particle size of one or more of the heated particles may decrease to a particle size that is below a detectable threshold, such that the heated particle may be undetectable to an exemplary flow sensor (e.g., a fluid sensor and/or a fluid composition sensor). In such an exemplary circumstance, the second particle data associated with the one or more heated particles may be defined at least in part by a decreased particle concentration (e.g., particle matter mass concentration and/or particle quantity), such that a relative particle characteristic may comprise a relative particle concentration defined by a comparison (e.g., a difference) between a first particle concentration associated with the first plurality of particles within the first fluid sample and a second particle concentration distribution associated with the one or more heated particles of the second fluid sample. By contrast, in various embodiments, an abundance of liquid content within the second fluid sample may be at least substantially low, such that the difference between a first particle concentration associated with the first plurality of particles and a second particle concentration associated with the one or more heated particles may be negligible (e.g., a relative particle concentration indicative of at least substantially zero change).

Further, in various embodiments wherein the liquid particle portion of one or more heated particles undergoes an at least partial evaporation, a solid particle portion of the one or more heated particles may remain at least substantially unaffected. In such an exemplary circumstance, a relative abundance of the one or more heated particles may undergo a shift towards a smaller particle size, as non-volatile components of an exemplary droplet may remain at least substantially consistent while a droplet size associated with the exemplary droplet may decrease. Accordingly, as described herein, a relative particle characteristic defined by a comparison (e.g., a difference) between a first particle size distribution associated with at least a portion of the first plurality of particles within the first fluid sample and a second particle size distribution associated with at least a portion of the one or more heated particles of the second fluid sample may be used as an indicator of the total liquid content within a volume of fluid. For example, in various embodiments, a relative particle characteristic comprising a relative particle size distribution corresponding to an at least substantially negligible (e.g., approximately zero) change and/or shift in particle size distribution relative to the second particle data may be indicative that an abundance of liquid content within the second fluid sample received by the exemplary flow device is at least substantial small.

Referring now to Block 1014, exemplary method 1000 may include determining a particle liquid content characteristic associated with the volume of fluid based at least in part on the one or more relative particle characteristic. In various embodiments, a particle liquid content characteristic may comprise a particle characteristic that is defined at least in part by a measurement and/or characterization of the liquid content within a plurality of particles and/or a volume of fluid. For example, in various embodiments, a particle liquid content characteristic may comprise a liquid-to-solid particle content ratio, a liquid particle portion volume, a solid particle portion volume, and/or the like.

As described herein, in various embodiments, the degree to which one or more particle characteristics associated with the one or more heated particles is affected by an evaporation of the liquid particle portions within the one or more heated particles may correlate to the abundance of liquid content (e.g., droplets) within the second fluid sample received by an exemplary fluid flow device. Accordingly, as described herein, one or more relative particle characteristics defined by one or more comparisons between one or more first particle characteristic(s) (e.g., first particle mass matter concentration, first particle quantity, first particle size, first particle size distribution, and/or the like) associated with at least a portion of the first plurality of particles within the first fluid sample and one or more corresponding second particle characteristic(s) associated with at least a portion of the one or more heated particles of the second fluid sample may be used as an indicator of one or more particle liquid content characteristic, such as, for example, a liquid-to-solid particle content ratio associated with a volume of fluid.

Referring now to Block 1016, exemplary method 1000 may include applying a compensation factor to at least a portion of the first particle data and the second particle data based at least in part on one or more of a fluid temperature, a fluid pressure, a fluid humidity, and a fluid flow rate associated with the volume of fluid. In various embodiments, a compensation factor may be applied to the estimated mass of each of the particles to account for one or both of a sensor operating condition associated with an exemplary fluid flow device and an ambient condition associated with an ambient environment. In various embodiments, for example, a compensation factor may be applied to one or more measured particle characteristics associated with at least a portion of a plurality of particles within a fluid sample to account for an ambient temperature, ambient pressure, and/or ambient humidity because each of the ambient temperature, the ambient pressure, and the ambient humidity may affect at least one operating configuration of one or more components of an exemplary sensor, such as, for example, a fluid composition sensor comprising an adhesive collection media, and/or may affect one or more operating conditions of an exemplary sensor, such as, for example, an operating condition of a heating chamber configured to defined a heated particle configuration of one or more heated particles. In various embodiments, the ambient temperature, ambient pressure, and ambient humidity, and/or fluid flow rate may be measured by either one or more auxiliary sensors of the fluid flow device, or by one or more remote sensors configured to transmit temperature, pressure, humidity, and/or flow data to the fluid flow device.

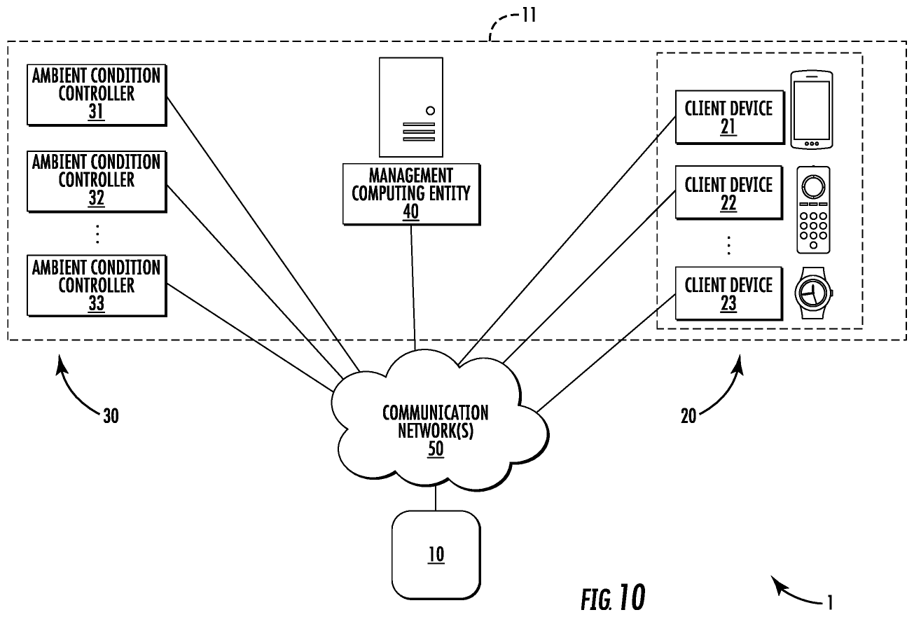

Referring now to Block 1018 of FIG. 8, exemplary method 1000 may include generating a control signal for an external device upon determining that the particle liquid content characteristic satisfies a particle liquid content threshold. As described herein, upon determining that a liquid particle portion characteristic (e.g., a ratio of liquid content to solid content and/or a percentage of a particle defined by particle liquid content) exceeds a threshold value, a control signal may be generated by an exemplary fluid flow device 10 for transmission to an external device, such as, for example, one or more components of an exemplary fluid flow monitoring system, as described herein. In such an exemplary circumstance, the control signal may be generated for transmission to one or more of a management computing entity, one or more client devices, one or more ambient condition controllers, as described herein in reference to FIG. 10. In various embodiments, the control signal may comprise an electrical signal and/or a data signal. In some embodiments, the control signal may be embodied as an indication to an external device that the ratio of liquid content to solid content within one or more particles of a fluid sample received by the fluid flow device 10 has exceeded a pre-defined safety threshold.

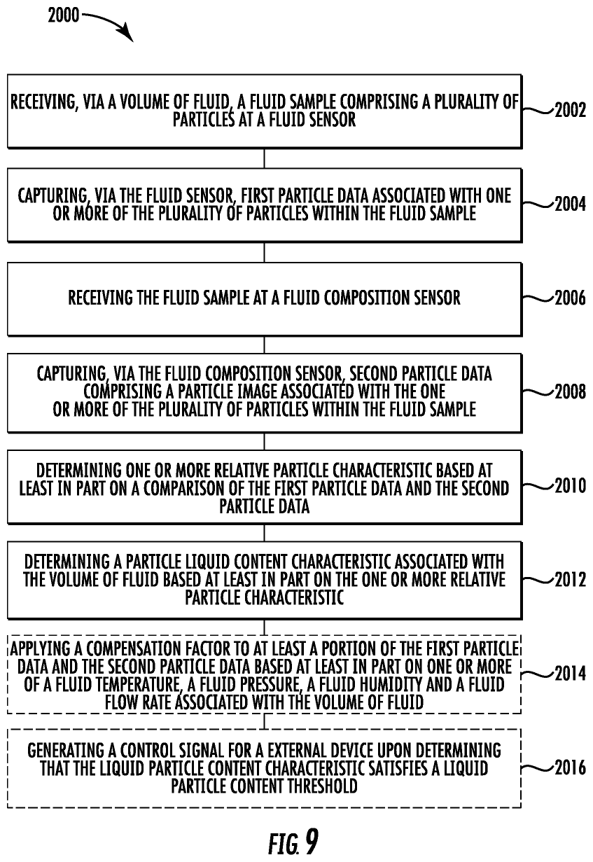

In various embodiments, as described herein, an exemplary fluid flow device configured to receive a fluid sample defining at least a portion of a volume of fluid from an ambient environment may be further configured to determine a particle liquid content characteristic associated with the volume of fluid. In various embodiments, a particle liquid content characteristic associated with the volume of fluid (e.g., associated with the fluid sample) may be based at least in part on a comparison between first particle data captured by a fluid sensor and second particle data captured by a fluid composition sensor, wherein the first and second particle data are each associated with at least a portion of a plurality of particles within the fluid sample. For example, referring now to FIG. 9, a flowchart of an exemplary method 2000 for determining a particle liquid content characteristic associated with a volume of fluid is provided. In some embodiments, one or more operations of the illustrated exemplary method 2000 may be executed by controlling a fluid flow device in accordance with one or more example embodiments described herein. For example, various operations discussed below with respect to exemplary method 2000 may be carried out using various components of an exemplary fluid flow device, such as, for example, an exemplary fluid flow device 10 as described above in reference to FIG. 1. In various embodiments, an exemplary fluid flow device utilized to execute one or more operations of exemplary method 2000 may comprise a controller, including one or more processors, a first flow sensor comprising a fluid sensor and a second flow sensor comprising a fluid composition sensor. In various embodiments, a fluid sensor utilized to execute one or more operations of exemplary method 2000 may comprise an exemplary fluid sensor 400, as described herein in reference to FIG. 2. Further, in various embodiments, a fluid composition sensor utilized to execute one or more operations of exemplary method 2000 may comprise an exemplary fluid composition sensor 500, as described herein in reference to FIG. 3. In various embodiments, an exemplary fluid flow device configured to execute one or more operations of exemplary method 2000 may be in communication with one or more external devices, such that a control signal generated by the fluid flow device may be transmitted to the one or more external devices. Various components referenced in relation to the exemplary fluid flow device may be included with or in communication with the fluid flow device.

As illustrated in FIG. 9, exemplary method 2000, at Block 2002, may include receiving, via a volume of fluid, a first sample comprising a plurality of particles at a fluid sensor. In various embodiments, the fluid sample may embody a sample volume of fluid that defines at least a portion of the volume of fluid and comprises a plurality of particles therein. In various embodiments, the volume of fluid defined in part by the fluid sample may correspond to a fluid within an ambient environment, such that the particles present within the fluid sample may be defined by one or more particle characteristics that are at least substantially similar to a particle characteristic of the fluid within the ambient environment (e.g., the volume of fluid). For example, in various embodiments, the plurality of particles received by an exemplary fluid sensor may be representative of a plurality of particles present within the fluid within the ambient environment.

Further, at Block 2004, first particle data associated with one or more of the plurality of particles within the fluid sample may be captured, via the fluid sensor. In various embodiments, as described herein, first particle data associated with a fluid sample may be captured by a fluid sensor. In various embodiments, the plurality of particles within the fluid sample may be received by the fluid sensor. In various embodiments, the first particle data may be captured by a fluid sensor configured to detect, measure, and/or characterize one or more particle characteristics (e.g., particle matter mass concentration, particle quantity, particle size, and/or the like) associated with one or more particles of the plurality within the fluid sample based at least in part on an optical scattering technique. For example, as described herein, first particle data associated with the plurality of particles within the fluid sample may be captured using a fluid sensor embodied as one or more of a particulate matter sensor, a particle sizer/counter, and/or any other suitable devices capable of detecting and/or measuring particle content within one or more volumes of fluid. In various embodiments, a fluid sensor may capture the first particle data, such as, for example, particle matter mass concentration data, particle quantity data, particle size data, and/or the like, associated with one or more of the plurality of particles within the fluid sample by utilizing a particle detector comprising a light beam generator and a pulse detector, collectively configured to monitor signal pulses generated at the pulse detector based upon the presence of the one or more particles within the exemplary fluid sensor.

Referring now to Block 2006, exemplary method 2000 may include receiving the fluid sample at a fluid composition sensor. In various embodiments, an exemplary fluid composition sensor configured to receive the fluid sample may comprise an exemplary fluid composition sensor 500, as described herein in reference to FIG. 3, and/or any other suitable particle imaging sensor capable of measuring particle content within one or more volumes of fluid using one or more particle imaging operations. As described herein, an exemplary fluid composition sensor may be configured to receive one or more of the plurality of particles within the fluid sample at a collection media disposed therein. In various embodiments, the collection media may comprise an adhesive material medium (e.g., a sticky gel-like substance), a liquid medium, a solid or quasi-solid surface, a heated medium, and/or the like.

At Block 2008, exemplary method 2000 may further include capturing second particle data associated with the one or more of the plurality of particles within the fluid sample. For example, as described herein, the fluid composition sensor may be configured for generating, identifying, calculating, and/or capturing particle data related to the particle composition of one or more particles of the plurality within the fluid sample. In various embodiments, second particle data captured by a fluid composition sensor may comprise a particle image captured using one or more particle imaging techniques, such as, for example, lensless holography, fluorescent imaging, and/or the like. Further, in various embodiments, a fluid composition sensor may capture further second particle data using one or more image focusing techniques, such as a computational technique (e.g., Angular Spectrum Propagation) and/or a mechanical technique (e.g., opto-mechanical adjustment). In various embodiments, the captured second particle data may further comprise particle data generated based at least in part on the captured particle image, such as, for example, particle type data, particle matter mass concentration data, particle quantity data, particle size data, and/or the like, associated with one or more of the plurality of particles within the fluid sample.

Referring now to Block 2010, exemplary method 2000 may further comprise determining one or more relative particle characteristic based at least in part on a comparison of the first particle data and the second particle data. In various embodiments, a relative particle characteristic may comprise one or more comparative data, images, particle characteristics, and/or the like that defines a first particle characteristic associated with the fluid sample as detected by the fluid sensor, relative to a corresponding second particle characteristic associated with fluid sample as measured by the fluid composition sensor. For example, in various embodiments, a relative particle characteristic may comprise a comparison of one or more particle characteristics defined by the first particle data captured by the fluid sensor to one or more particle characteristics defined by the second particle data captured by the fluid composition sensor.

In various embodiments, a relative particle characteristic may correspond to one or more relationships, differences, similarities, evolutions, and/or the like between the first particle data captured using, for example, one or more optical scattering techniques, and the second particle data capture using, for example, one or more particle imaging techniques. For example, as described herein, a relative particle characteristic associated with the first particle data and the second particle data may be defined at least in part by a difference between a first particle characteristic detected by a fluid sensor and a corresponding second particle characteristic detected by a fluid composition sensor, wherein the difference defining the relative particle characteristic may be the resultant of the different particle detection/measurement configurations and/or limitations respectively exhibited by the fluid sensor and the fluid composition sensor. For example, one or more particle characteristics defined within the first particle data captured by an exemplary fluid sensor may be affected by the inability of a fluid sensor using optical scattering techniques to classify a particle by particle type and/or an inability to distinguish between a liquid particle portion and a solid particle portion within one or more particles. As a further non-limiting example, one or more particle characteristics defined within either the first particle data or the second particle data may be affected based at least in part on a physical configuration of the fluid sensor and/or the fluid composition sensor, such as, for example, the particle size range that the sensor is configured to detect (e.g., PM10, PM4, PM2.5, or PM1).

By way of further non-limiting example, an exemplary fluid composition sensor may be configured to capture at least a portion of the plurality of particles within a fluid sample at a collection media within the fluid composition sensor in order to enable a capturing of the second particle data, as described herein. By contrast, the first particle data may be captured by an exemplary fluid sensor using one or more optical scattering operations such that the physical capture of one or more of the particles is not required. Accordingly, the distinct operations and/or physical configurations of the fluid sensor and the fluid composition sensor may cause the second particle data to differ at least in part from the first particle data captured by the fluid sensor. For example, in various embodiments, based at least in part on the physical interaction of the one or more particles (e.g., a liquid particle portion) with the collection media, second particle data may be defined at least in part by a particle concentration data and/or particle size data that is at least substantially smaller than the corresponding particle concentration data and/or particle size data defined within the first particle data. As a non-limiting example, in an exemplary circumstance wherein the one or more particles of the plurality within the fluid sample are captured by the fluid composition sensor at a sticky adhesive material using an impactor nozzle, one or more shear forces encountered in a compressed airflow through the impactor nozzle may cause a weakly bound particle, such as, for example, a particle comprising a liquid particle portion, to at least partially deteriorate and/or fall apart into one or more smaller particle elements. Further, in various embodiments, the high airflow velocity defined by the one or more particles of the plurality traveling through an exemplary impactor nozzle of the fluid composition sensor may cause at least a portion of a liquid particle portion within the one or more particles to evaporate. Further still, in such an exemplary circumstance, a liquid particle portion may comprise an index of refraction that is at least substantially similar to an index of refraction of the sticky adhesive material of the collection media, such that a liquid particle portion of the one or more particles received by the fluid composition sensor at the collection media may be distinguishable from the solid particle portion of the one or more particles. As described herein, in various embodiments wherein an a collection media within a fluid composition sensor comprises a liquid medium, a solid surface, and/or a heated solid surface, a liquid particle portion of one or more particles of the plurality that physically engages said collection media may be subject to dissolution, deformation (e.g., due to surface tension effects), and/or evaporation, respectively.

In various embodiments, a relative particle characteristic may comprise a difference between a first particle characteristic defined by the first particle data and a second particle characteristic defined by the second particle data, as described herein. In such an exemplary circumstance, the relative particle characteristic may be determined using the equations below:

Difference=α[Second Particle Characteristic]−β[First Particle Characteristic]

In the exemplary equation described above, α and β may each represent a respective sensor calibration factor that may be empirically determined and may correspond at least in part the specific type of sensor used to capture the first particle data and/or the second particle data, as described herein. For example, a relative particle characteristic resulting from the exemplary equation provided above (e.g., a difference) may be calibrated so that a difference value of at least substantially zero may be indicative of the plurality of particles within the fluid sample having a low concentration of liquid content (e.g., droplets). By contrast, a relative particle characteristic resulting from the above equation that has a difference value that is at least substantially different than zero may indicate that at least a portion of the plurality of particles within the fluid sample has a relatively high (e.g., non-negligible) concentration of liquid content therein. In various embodiments, the calibration factors α and β provided above may also define one or more compensation factors that may be selectively defined so as to account for one or more environmental parameters such as, for example, temperature, humidity, pressure, and/or location.

Further, in various embodiments, a relative particle characteristic may comprise a ratio between a first particle characteristic defined by the first particle data and a second particle characteristic defined by the second particle data, as described herein. In such an exemplary circumstance, the relative particle characteristic may be determined using the equations below:

$$Ratio = γ \frac{[ Second Particle Characteristic ]}{[ First Particle Characteristic ]}$$

In the exemplary equation described above, γ represents a sensor calibration factor that may be empirically determined and may correspond at least in part the specific type of sensors used to capture the first particle data and/or the second particle data, as described herein. For example, a relative particle characteristic resulting from the exemplary equation provided above (e.g., a ratio) may be calibrated so that the ratio value is at least approximately one when the concentration of liquid content (e.g., droplets) is at least approximately zero. By contrast, a relative particle characteristic resulting from the above equation that has a ratio value that diverges from a value of at least approximately one may indicate that at least a portion of the plurality of particles within the fluid sample has a relatively high (e.g., non-negligible) concentration of liquid content therein. In various embodiments, the sensor calibration factor γ provided above may also define a compensation factor that may be selectively defined so as to account for one or more environmental parameters such as, for example, temperature, humidity, pressure, and/or location.

Referring now to Block 2012, exemplary method 2000 may include determining a particle liquid content characteristic associated with the volume of fluid based at least in part on the one or more relative particle characteristic. As described herein, in various embodiments, a particle liquid content characteristic may comprise a particle characteristic that is defined at least in part by a measurement and/or characterization of the liquid content within a plurality of particles and/or a volume of fluid. For example, in various embodiments, a particle liquid content characteristic may comprise a liquid-to-solid particle content ratio, a liquid particle portion volume, a solid particle portion volume, and/or the like.

As described herein, in various embodiments, the degree to which first particle data, second particle data, and/or one or more relative particle characteristics associated with the plurality of particles within the fluid sample is affected by the distinct physical configurations exhibited by a fluid sensor and a fluid composition sensor, respectively, may correlate to an abundance of liquid content (e.g., droplets) within the fluid sample received by an exemplary fluid flow device. Accordingly, as described herein, one or more relative particle characteristics defined by one or more comparisons between one or more first particle characteristic(s) (e.g., first particle mass matter concentration, first particle quantity, first particle size, first particle size distribution, and/or the like) associated with the first particle data captured by the fluid sensor and one or more corresponding second particle characteristic(s) associated with the second particle data captured by the a fluid composition sensor may be used as an indicator of one or more particle liquid content characteristic, such as, for example, a liquid-to-solid particle content ratio associated with a volume of fluid.

Blocks 2014 and 2016 of the exemplary method 2000 correspond to various operations that are at least substantially similar to the steps previously described with respect to Blocks 1016 and 1018, respectively, as illustrated in FIG. 8.

FIG. 10 illustrates an example fluid flow management system 1 in accordance with various embodiments discussed herein. In particular, an exemplary fluid flow management system 1 may be configured for monitoring and/or controlling one or more ambient conditions within a facility using an exemplary fluid flow device 10, as described herein. As illustrated, the fluid flow management system 1 may include industrial equipment such as, for example, the equipment of a heating, ventilation, and air conditioning (HVAC) system of a facility (e.g., building), such as, for instance, an office building (e.g., a commercial office building), or a retail facility. However, embodiments of the present disclosure are not limited to a particular type of facility, or to a particular type of industrial equipment. For instance, embodiments of the present disclosure can be used in a process plant system, conveyor belt system, or any other type of industrial and/or commercial setting that may be accessed by one or more people.

FIG. 10 further schematically illustrates various data flows among components of an exemplary fluid flow management system 1 in accordance with some embodiments discussed herein. As shown in FIG. 10, the fluid flow management system 1 may comprise various components for monitoring and/or controlling one or more ambient conditions within a facility. For example, as shown in FIG. 1, fluid flow management system 1 may comprise an exemplary fluid flow device 10, as described herein, and an HVAC system 11. As illustrated, in various embodiments, an HVAC system 11 may comprise one or more client devices 20 (e.g., 21, 22, 23), one or more ambient condition controllers 30 (e.g., 31, 32, 33), a management computing entity 40, and/or the like. Various components of the fluid flow management system 1 may be in electronic communication with, for example, another component of the fluid flow management system 1 over various wireless or wired communication networks 140, as described herein. In various embodiments, a fluid flow device 10 and/or a managing computing entity 40 may be configured to communicate with one or more system components, such as, for example, a client device 21 executing a mobile application. In various embodiments, a client device may include, without limitation, smart phones, tablet computers, laptop computers, wearables (e.g., a smart watch), personal computers, and/or the like. A client device may execute an “app” to interact with one or more components of the fluid flow monitoring system 1, such as, for example, the fluid flow device and the management computing entity 40.

In various embodiments, the fluid flow device 10 and each of the components of the HVAC system 11 of the fluid flow monitoring system 1 may be in electronic communication with, for example, one another over the same or different wireless or wired networks 50 including, for example, a wired or wireless Personal Area Network (PAN), Local Area Network (LAN), Metropolitan Area Network (MAN), Wide Area Network (WAN), and/or the like. For example, in various embodiments, the one or more communication networks 50 described herein may use any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Wibree, Bluetooth protocols, wireless universal serial bus (USB) protocols, and/or any other wireless protocol. Additionally, while FIG. 1 illustrates certain system entities as separate, standalone entities, the various embodiments are not limited to such an example particular architecture.

As described herein, an exemplary HVAC system 11 can be used to monitor, control, and/or adjust one or more ambient conditions within a facility based at least in part on one or more control signals, as described herein. In various embodiments, management computing entity 40 may comprise a computing device, such as, for example, a server, associated with the fluid flow monitoring system 1. In various embodiments, the management computing entity 40 may be accessed by authorized individuals and/or client devices. The management computing entity 40 may be configured to store and/or transmit data associated with an exemplary HVAC system 11 and/or particle data captured by an exemplary fluid flow device 10. For example, in various embodiments, the management computing entity 40 may be configured to execute one or more operations so as to enable the fluid flow monitoring system 1 to track various particle data captured by a fluid flow device 10 comprising liquid content concentrations (e.g., ratios of liquid content to solid content and/or percentages of various particles defined by particle liquid content), determine a location within a facility of one or more particles defined by an at least substantially high liquid content concentration, utilize location data, a digital model of the facility, various operational data associated with the HVAC system 11, and/or occupant data to holistically analyze a facility ecosystem defined by various fluid flow paths extending throughout the facility, determine predicted and/or actual positions of one or more occupants within the facility, and/or determine one or more appropriate mitigation responses in order to at least substantially minimize particle liquid content within an ambient volume of fluid so as to minimize exposure to one or more facility occupants. In various embodiments, the management computing entity 40 may be configured to display at least a portion of the particle data captured by an exemplary fluid flow device 10, including, as a non-limiting example, one or more particle liquid content characteristics, at an interface associated therewith. In various embodiments, a management computing entity 40 may be configured to receive and/or process one or more control signals generated by the fluid flow device 10, and, subsequently, may transmit (e.g., selectively distribute) the control signal to one or more ambient condition controllers and/or execute one or more instructions corresponding to one or more mitigating response operations, as described in further detail herein.

In various embodiments, an exemplary ambient condition controller may comprise a device configured to configured to receive an instructional signals and to determine, set, and/or change a corresponding ambient condition within at least a portion of a facility, such as for example, within one or more zones (e.g., rooms, areas, spaces, and/or floors) of the facility, in order to keep a zones in a comfort and/or safe state for one or more occupants therein. As non-limiting examples, the one or more ambient condition controllers 30 of an exemplary fluid flow monitoring system 1 may comprise a thermostat, a humidifier, a flow valve, and/or the like. For example, as described herein, an exemplary fluid flow management system 1 may be configured selectively and/or automatically control at least a portion of the one or more ambient conditions (e.g., via one or more ambient condition controllers 30) within a facility based at least in part on a control signal generated by the fluid flow device 10.

In various embodiments, a fluid flow device 10 may be configured to operate at least substantially continuously, such that the fluid flow device 10 may detect a dangerous condition within a facility in near-real time. In various embodiments, as described herein, an exemplary fluid flow device 10 may determine a particle liquid content characteristic associated with a volume of fluid based at least in part on a relative particle characteristic that is determined based on a comparison of first particle data and second particle data captured at respective stages of a substantially two-stage particle detection/characterization operation, as described herein. For example, the fluid flow sensor 10 may be configured to determine a particle liquid content characteristic comprising a ratio of liquid content to solid content within one or more particles of a plurality of particles received by the fluid flow device 10 via a fluid sample. Further, in various embodiments, the fluid flow device 10 may be configured to further determine that the determined particle liquid content characteristic satisfies one or more particle criteria comprising a threshold value. For example, the fluid flow device 10 may determine that the ratio of liquid content to solid content within one or more particles exceeds a threshold ratio value. In various embodiments, upon determining that a liquid particle portion characteristic (e.g., a ratio of liquid content to solid content and/or a percentage of a particle defined by particle liquid content) exceeds the threshold value, the fluid flow device 10 may generate a control signal for transmission to an external device, such as, for example, a management computing entity 40 of the fluid flow monitoring system 1. In various embodiments, the control signal may comprise an electrical signal and/or a data signal. In some embodiments, the control signal may be embodied as an indication to an external device that the ratio of liquid content to solid content within one or more particles of a fluid sample received by the fluid flow device 10 has exceeded a pre-defined safety threshold. For example, in various embodiments wherein the fluid flow device 10 determines that the particle liquid content characteristic associated with a fluid sample taken from a first location within a facility has satisfied the particle liquid content threshold value, the fluid flow monitoring system 1 may be configured to store historical system data (e.g., at management computing entity 40) comprising timestamp data, location data, and particle data captured by the fluid flow device 10, so as to correlate the particular instance at which the threshold was satisfied (e.g., exceeded) with a corresponding timestamp and a corresponding location within the facility.

In various embodiments, the fluid flow device 10 may be configured to transmit the generated control signal to one or more components of the fluid flow monitoring system 1, such as, for example, the management computing entity 40 and/or one or more of the client devices 20 of the HVAC system 11, via one or more communication networks 50. In various embodiments, a generated control signal may comprise one or more executable instructions configured to cause the management computing entity 40 to transmit a corresponding alert signal to each of the client devices 21, 22, 23 associated with the HVAC system 11. For example, the alert signal transmitted to the client devices 21, 22, 23 may comprise data configured for display at a user interface of the client device, which may include, for example, a warning message, a graphical representation of the value of the liquid particle portion characteristic determined be the fluid flow device, corresponding location data, evacuation instructions associated with the facility, and/or the like.

In various embodiments, the control signal generated by the fluid flow device 10 may comprise one or more executable instructions configured to cause the HVAC system 11 to initiate and/or execute one or more responsive mitigating operations upon receiving the control signal from the fluid flow device 10. In various embodiments, a fluid flow monitoring system 1 may be configured to execute one or more responsive mitigating operations comprising transmitting to an ambient condition controller 31 one or more signals comprising executable instructions configured to cause the ambient condition controller 31 to adjust an ambient condition corresponding thereto. As a non-limiting example provided for illustrative purposes, such an exemplary responsive mitigating operations may comprise adjusting one or more of the ambient condition controllers 20 so as to increase in fluid circulation throughout at least a portion of the facility (e.g., an increased air flow volume and/or increased air flow rate), disperse at least a portion of an airflow throughout a plurality of zones within the facility, dispense at least a portion of the fluid circulating throughout the facility out from the facility via a facility fluid exhaust, increase/decrease a temperature within the facility, and/or increase/decrease a humidity within the facility. Further, in various embodiments, a fluid flow monitoring system 1 may be configured to execute one or more responsive mitigating operations comprising implementing increased fluid filtration measures, disinfecting and/or sterilizing at least a portion of the facility using one or more of a radiation means, an electrical means, a chemical means, and/or a heat treatment means, and/or selectively re-direct at least a portion of an airflow such that the airflow is dispersed to a plurality of zones throughout the facility, so as to divert and/or contain one or more worrisome particles (e.g., particles defined by a high liquid content concentration) may be diverted away from critical areas within the facility. For example, in various embodiments, the fluid flow monitoring system 1 may comprise one or more air diverter flaps selectively configurable between a plurality of positions so as to define the directional configuration of at least a portion of the airflow throughout the facility.

In various embodiments, an exemplary fluid flow device 10 of a fluid flow monitoring system 1 may be configured to transmit one or more informational signal to the HVAC system 11 in response to determining that the ratio of liquid content to solid content within one or more air volumes (e.g., a liquid concentration) has returned to a value at least substantially below the threshold ratio value described herein.

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A fluid flow device for detecting a particle liquid content characteristic, the device comprising:
one or more fluid flow device inlets configured to receive a first fluid sample comprising a first plurality of particles and a second fluid sample comprising a second plurality of particles;
a heating element configured to heat at least a portion of the second plurality of particles such that one or more of the second plurality of particles comprises one or more heated particles;
a flow sensor configured to receive the first fluid sample and capture first particle data associated with the first plurality of particles; and
a controller configured to determine a particle liquid content characteristic based at least in part on the first particle data and second particle data associated with the one or more heated particles, wherein the particle liquid content characteristic is defined at least in part by a liquid particle portion of one or more particles received by the fluid flow device.

2. The fluid flow device of claim 1, wherein the flow sensor comprises a fluid sensor configured to capture the first particle data associated with the first plurality of particles using an optical scattering operation.

3. The fluid flow device of claim 1, wherein the flow sensor comprises a fluid composition sensor configured to capture the first particle data associated with the first plurality of particles using a particle imaging operation.

4. The fluid flow device of claim 3, wherein the particle imaging operation comprises lensless holography.

5. The fluid flow device of claim 1, wherein the flow sensor is further configured to receive the second fluid sample and capture the second particle data associated with the one or more heated particles.

6. The fluid flow device of claim 1, further comprising a first fluid flow path configured to receive the first fluid sample and a second fluid flow path configured to receive the second fluid sample.

7. The fluid flow device of claim 6, further comprising a second flow sensor configured to receive the one or more heated particles from the second fluid delivery conduit and capture the second particle data associated with the at least a portion of the one or more heated particles.

8. The fluid flow device of claim 1, wherein the particle liquid content characteristic comprises a ratio defined at least in part by a first particle characteristic value and a second particle characteristic value, wherein the first particle characteristic value is defined by the first particle data associated with the first plurality of particles, and wherein the second particle characteristic value is defined by the second particle data associated with the one or more heated particles.

9. The fluid flow device of claim 1, wherein the particle liquid content characteristic comprises a difference between a first particle characteristic value and a second particle characteristic value, wherein the first particle characteristic value is defined by the first particle data associated with the first plurality of particles, and wherein the second particle characteristic value is defined by the second particle data associated with the one or more heated particles.

10. The fluid flow device of claim 1, wherein the controller is further configured to determine that the particle liquid content characteristic satisfies a threshold liquid content concentration value; and upon determining that the particle liquid content characteristic satisfies the threshold liquid content concentration value, generate a control signal for transmission to an external device.

11. The fluid flow device of claim 1, wherein the heating element is configured to heat the at least a portion of the second plurality of particles within a fluid flow conduit fluidly connected to at least one of the one or more fluid flow device inlets such that at least a portion of the fluid flow conduit defines a heated flow path.

12. A fluid flow device for detecting a particle liquid content characteristic, the device comprising:
a fluid sensor configured to receive a fluid sample comprising a plurality of particles disposed therein and generate first particle data associated with the plurality of particles using an optical scattering operation;
a fluid composition sensor configured to receive the fluid sample comprising the plurality of particles and generate second particle data associated with the plurality of particles using a particle imaging operation;
a controller configured to determine a particle liquid content characteristic associated with the fluid sample based at least in part on a comparison of the first particle data and the second particle data, wherein the particle liquid content characteristic is defined at least in part by a liquid particle portion within one or more particles of the plurality received by the fluid flow device.

13. The fluid flow device of claim 12, wherein the fluid composition sensor comprises an imaging device configured to capture a particle image of one or more particles of the plurality using lensless holography.

14. The fluid flow device of claim 12, wherein the particle liquid content characteristic is based at least in part on a ratio of a second particle characteristic value to a first particle characteristic value, wherein the second particle characteristic value is defined by the second particle data associated with the plurality of particles, and wherein the first particle characteristic value is defined by the first particle data associated with the plurality of particles.

15. The fluid flow device of claim 12, wherein the particle liquid content characteristic is based at least in part on a difference between a second particle characteristic value and a first particle characteristic value, wherein the second particle characteristic value is defined by the second particle data associated with the plurality of particles, and wherein the first particle characteristic value is defined by the first particle data associated with the plurality of particles.

16. The fluid flow device of claim 12, wherein the controller is further configured to determine that the particle liquid content characteristic satisfies a threshold liquid content concentration value; and upon determining that the particle liquid content characteristic satisfies the threshold liquid content concentration value, generate a control signal for transmission to an external device.

17. The fluid flow device of claim 12, wherein the fluid sensor defines at least a portion of a fluid flow path, and wherein the fluid sensor and the fluid composition sensor are positioned along the fluid flow path such that the fluid sample flows through the fluid sensor upstream from the fluid composition sensor.

18. A method for controlling a fluid flow monitoring system, the method comprising:
monitoring, via a fluid flow device, a particle liquid content characteristic associated with a fluid sample received by the fluid flow device, wherein the particle liquid content characteristic is defined at least in part by a liquid particle portion within one or more of the plurality of particles; and
upon determining that the particle liquid content characteristic satisfies a particle liquid content threshold value, generating a control signal for transmission to second system device of the fluid flow monitoring system,
wherein the particle liquid content threshold value defines a threshold particle liquid content concentration indicative of the presence of one or more droplets present within the fluid sample received by the fluid flow device.

19. The method of claim 18, further comprising:
in response to receiving the receiving the control signal at the secondary system device, executing one or more responsive mitigating operations to reduce a particle liquid content concentration associated with the one or more particles within the fluid sample.

20. The method of claim 19, wherein executing the one or more responsive mitigating operations comprises causing an ambient condition controller to adjust one or more ambient conditions defining at least a portion of an ambient environment within a facility.
